(19) United States
(12) Patent Application Publication
(10) Pub. No.: US 2025/0264878 A1
(43) Pub. Date: Aug. 21, 2025

(54) SYSTEMS AND METHODS FOR ACCURATE INDOOR POSITIONING IN LARGE SCALE FACILITIES

(71) Applicant: Luci Mobility, Inc., Brentwood, TN (US)

(72) Inventors: Jered H. DEAN, Arvada, CO (US); Dan A. PRESTON, Bainbridge Island, WA (US); Filip MLEKICKI, Brooklyn, NY (US); Ross LANNEN, Denver, CO (US); Kevin LANNEN, Westminster, CO (US); Adam MORGAN, Arvada, CO (US); Joshua BURMEISTER, Denver, CO (US)

(21) Appl. No.: 19/204,112

(22) Filed: May 9, 2025

Related U.S. Application Data
(63) Continuation-in-part of application No. 18/922,815, filed on Oct. 22, 2024.
Application No. 18/922,815 is a continuation of application No. 17/726,275, filed on Apr. 21, 2022, now Pat. No. 12,158,758.
Application No. 17/726,275 is a continuation of application No. 16/101,152, filed on Aug. 10, 2018, now Pat. No. 11,334,070.
(60) Provisional application No. 63/644,974, filed on May 9, 2024.
(60) Provisional application No. 62/696,497, filed on Jul. 11, 2018.
(60) Provisional application No. 62/639,293, filed on Mar. 6, 2018.
(60) Provisional application No. 62/612,617, filed on Dec. 31, 2017.
(60) Provisional application No. 62/543,896, filed on Aug. 10, 2017.

(51) Int. Cl. G05D 1/00; A61G 5/04; B60W 30/095; G05D 1/247; G05D 1/617; G05D 1/81; G06T 7/292; G06V 20/58

(52) U.S. Cl. CPC G05D 1/247; A61G 5/04; G05D 1/617; G05D 1/81; G06T 7/292; G06V 20/58; A61G 2203/22; A61G 2203/72; A61G 2203/726; G06T 2207/30261

(57) ABSTRACT

An indoor positioning system for use in wayfinding and navigation that provides location with limited infrastructure. The positioning system comprising at least one transceiver transmitting one or more signals used by at least two additional transceivers to calculate an estimated location of the first transceiver for use by other systems for wayfinding and navigation.

### CROSS-REFERENCE TO RELATED APPLICATIONS

The present application is also related to and claims priority under 35 U.S.C. § 119(e) from U.S. Patent Application No. 63/644,974 filed May 9, 2024, titled “Systems and Methods for Accurate Indoor Positioning in Large Scale Facilities,” the entire contents of which is incorporated herein by reference for all purposes.

The present application is a continuation-in-part of and is related to U.S. Nonprovisional patent application. Ser. No. 18/922,815 filed Oct. 22, 2024, titles “Systems and Methods for Coordinated Autonomous Operation of Motorized Mobile Devices,” which is a continuation of U.S. Nonprovisional patent application. Ser. No. 17/726,275 filed Apr. 21, 2022, now U.S. Pat. No. 12,158,758, titled “Systems and Methods for Adjustment of a Seat of a Motorized Mobile System,” which is a continuation of U.S. Nonprovisional patent application. Ser. No. 16/101,152 filed Aug. 10, 2018, now U.S. Pat. No. 11,334,070, titled “Systems and Methods for Predictions of State of Objects for a Motorized Mobile System,” which claims priority under 35 U.S.C. § 119 to U.S. Provisional Patent Application No. 62/696,497 filed Jul. 11, 2018, titled “Systems and Methods for Enhanced Autonomous Operations of a Motorized Mobile System,” to U.S. Provisional Patent Application No. 62/639,293 filed Mar. 6, 2018, titled “Systems and Methods for Enhanced Autonomous Operations of a Motorized Mobile System,” to U.S. Provisional Patent Application No. 62/612,617 filed Dec. 31, 2017, titled “Systems and Methods for Enhanced Autonomous Operations of a Motorized Mobile System,” and to U.S. Provisional Patent Application No. 62/543,896 filed Aug. 10, 2017, titled “Systems and Methods for Motorized Mobile Systems,” which are incorporated herein by reference in their entirety.

The present application is related to U.S. Nonprovisional patent application. Ser. No. 16/858,704 filed Apr. 26, 2020, now U.S. Pat. No. 11,730,645, titled “Systems and Methods to Updated a Motorized Mobile Chair to a Smart Motorized Mobile Chair,” to U.S. Nonprovisional patent application. Ser. No. 15/880,663 filed Jan. 26, 2018, now U.S. Pat. No. 11,075,910, titled “Secure Systems Architecture for Integrated Motorized Mobile Systems,” to U.S. Nonprovisional patent application. Ser. No. 15/880,686 filed Jan. 26, 2018, U.S. Pat. No. 11,154,442, titled “Federated Sensor Array for Use with a Motorized Mobile System and Method of Use,” and to U.S. Nonprovisional patent application. Ser. No. 15/880,699 filed Jan. 26, 2018, now U.S. Pat. No. 10,656,652, titled “System and Methods for Sensor Integration in Support of Situational Awareness for a Motorized Mobile System,” all of which are incorporated herein by reference in their entirety.

### STATEMENT REGARDING FEDERAL RIGHTS

This invention was made with government support under grant number DE-SC0022679 awarded by the Department of Energy. The government has certain rights in the invention.

### COPYRIGHT NOTICE

Contained herein is material that is subject to copyright protection. The copyright owner has no objection to the facsimile reproduction by anyone of the patent document or the patent disclosure, as it appears in the United States Patent and Trademark Office patent file or records, but otherwise reserves all rights to the copyright whatsoever. The following notice applies to the software, screenshots and data as described below and in the drawings hereto and All Rights Reserved.

### FIELD

This disclosure relates generally to indoor positioning, localization systems and sensor systems.

### BACKGROUND

Indoor positioning systems (IPS), also referred to as a real-time location system or a real-time localization system (RTLS), are technologies designed to determine the location of assets or people within indoor environments. Unlike GPS, which is optimized for outdoor navigation where receivers have a clear view of the sky so that they can accurately receive data from overhead satellites, IPS uses technologies to address challenges unique to indoor environments, such as signal attenuation and multipath effects caused by walls and other obstructions in built environments. As used herein, indoor environments include any built structure or environment where traditional GPS is not reliable, or sufficiently accurate, for determining the position of an object or person. Indoor environments may include, for example, the inside of buildings, in parking structures, in dense urban environments, inside of large ships, in underground facilities such as mines, and the like.

Accurate, up-to-date location information is critical to managing operations, providing wayfinding, and autonomously deploying assets in indoor environments. Several commercial off-the-shelf indoor localization technologies and systems have been evaluated and tested. However, for various reasons, these systems do not meet current market needs. For example:
Bluetooth low-energy (BLE) technology alone is not accurate or robust enough to meet robot or wayfinding needs in large facilities like airports.
Commercial ultra-wideband (UWB) systems can provide the accuracy and range needed, but traditional implementations require too much infrastructure to be realistically deployed in existing large facilities.

In addition to the challenges of localization, sending data communications to connect localization infrastructure, supporting fleet communication and connecting assets in large facilities is a challenge. The upfront and total cost of ownership and effort of maintaining a stable network across such large-scale facilities, is significant.

What is needed, therefore, are new techniques for providing localization and communication in large facilities that enable a robust, accurate, and cost-effective IPS solution.

### SUMMARY

In one aspect, a processing system for an indoor positioning.

In another aspect, a processing method for an indoor positioning system that provides control instructions and/or data to robots, third party apps, local services, and remote services.

Applicant herein expressly incorporate(s) by reference all of the following materials identified in each paragraph below. The incorporated materials are not necessarily “prior art”.

Bluetooth SIG: “Bluetooth Core Specification”, v5.0.

FiRa Consortium: “FiRa Physical Layer (PHY) Technical Specification”, V2.0.0.

802.11-2016: “IEEE Standard for Information technology—Telecommunications and information exchange between systems Local and metropolitan area networks—Specific requirements—Part 11: Wireless LAN Medium Access Control (MAC) and Physical Layer (PHY) Specifications”.

802.11-2016: “IEEE Standard for Information technology—Telecommunications and information exchange between systems Local and metropolitan area networks—Specific requirements—Part 11: Wireless LAN Medium Access Control (MAC) and Physical Layer (PHY) Specifications Amendment 2: Sub 1 GHz License Exempt Operation”.

If it is believed that any of the above-incorporated material constitutes “essential material” within the meaning of 37 CFR 1.57(d)(1)-(3), applicant(s) reserve the right to amend the specification to expressly recite the essential material that is incorporated by reference as allowed by the applicable rules.

Aspects and applications presented here are described below in the drawings and detailed description. Unless specifically noted, it is intended that the words and phrases in the specification and the claims be given their plain and ordinary meaning to those of ordinary skill in the applicable arts. The inventors are aware that they can be their own lexicographers if desired. The inventors expressly elect, as their own lexicographers, to use only the plain and ordinary meaning of terms in the specification and claims unless they clearly state otherwise and expressly set forth the “special” definition of that term. Absent such clear statements of intent to apply a “special” definition, it is the inventors' intent and desire that the plain and ordinary meaning to the terms be applied to the interpretation of the specification and claims.

Further, the inventors are informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f) to define the systems, methods, processes, and/or apparatuses disclosed herein. To the contrary, if the provisions of 35 U.S.C. § 112(f) are sought to be invoked to define the embodiments, the claims will specifically and expressly state the exact phrases “means for” or “step for” and will also recite the word “function” (i.e., will state “means for performing the function of . . . ”), without also reciting in such phrases any structure, material, or act in support of the function. Thus, even when the claims recite a “means for performing the function of . . . ” or “step for performing the function of . . . ”, if the claims also recite any structure, material, or acts in support of that means or step then it is the clear intention of the inventors not to invoke the provisions of 35 U.S.C. § 112(f). Moreover, even if the provisions of 35 U.S.C. § 112(f) are invoked to define the claimed embodiments, it is intended that the embodiments not be limited only to the specific structures, materials, or acts that are described in the preferred embodiments, but in addition, include any and all structures, materials, or acts that perform the claimed function as described in alternative embodiments or forms, or that are well known present or later-developed equivalent structures, materials, or acts for performing the claimed function.

### BRIEF DESCRIPTION OF THE DRAWINGS

A more complete understanding of the systems, methods, processes, and/or apparatuses disclosed herein may be derived by referring to the detailed description when considered in connection with the following illustrative figures. In the figures, like-reference numbers refer to like-elements or acts throughout the figures.

FIG. 1 depicts an embodiment of an indoor position system (IPS) according to aspects of the present disclosure.

FIG. 2 depicts a block diagram of a tag device for use in an example IPS according to aspects of the present disclosure.

FIG. 3 depicts a block diagram of an anchor device for use in an example IPS according to aspects of the present disclosure.

FIG. 4 depicts a block diagram of a localization server according to aspects of the present disclosure

FIG. 5 depicts one embodiment of an IPS controller for use in an example IPS according to aspects of the present disclosure.

FIG. 6 depicts a robotic vehicle with an integrated tag device for use in an example IPS according to aspects of the present disclosure.

FIG. 7 depicts an anchor frame of reference according to aspects of the present disclosure.

FIG. 8 depicts a facility frame of reference according to aspects of the present disclosure.

FIG. 9 depicts a functional flow diagram of a Time Difference of Arrival (TDoA) localization according to aspects of the present disclosure.

FIG. 10 depicts a functional flow diagram of downlink TDoA localization according to aspects of the present disclosure.

FIG. 11 depicts a functional block diagram of an Angle of Arrival (AoA calculation according to aspects of the present disclosure.

FIG. 12 depicts a TDoAoA calculation process according to aspects of the present disclosure.

FIG. 13 depicts an exemplary flexible anchor topology according to aspects of the present disclosure.

FIG. 14 depicts example anchor antenna configurations according to aspects of the present disclosure.

FIG. 15 depicts an example anchor layout in a part of a large facility according to aspects of the present disclosure.

FIG. 16 depicts an embodiment of a shared, real-time map of an area being updated and used by multiple devices according to aspects of the present disclosure.

FIG. 17 depicts a facility operations management system which integrates an IPS system where multiple, external sources are incorporated according to aspects of the present disclosure.

FIG. 18 depicts an embodiment of an operations management user interface that uses IPS outputs according to aspects of the present disclosure.

Elements and acts in the figures are illustrated for simplicity and have not necessarily been rendered according to any particular sequence or embodiment.

### DETAILED DESCRIPTION

In the following description, and for the purposes of explanation, numerous specific details, process durations, and/or specific formula values are set forth in order to provide a thorough understanding of the various aspects of exemplary embodiments. However, it will be understood by those skilled in the relevant arts that the apparatus, systems, and methods herein may be practiced without all of these specific details, process durations, and/or specific formula values. Other embodiments may be utilized and structural and functional changes may be made without departing from the scope of the apparatus, systems, and methods herein. It should be noted that there are different and alternative configurations, devices, and technologies to which the disclosed embodiments may be applied. The full scope of the embodiments is not limited to the examples that are described below.

In the following examples of the illustrated embodiments, references are made to the accompanying drawings which form a part hereof, and in which is shown by way of illustration various embodiments in which the systems, methods, processes, and/or apparatuses disclosed herein may be practiced. It is to be understood that other embodiments may be utilized and structural and functional changes may be made without departing from the scope.

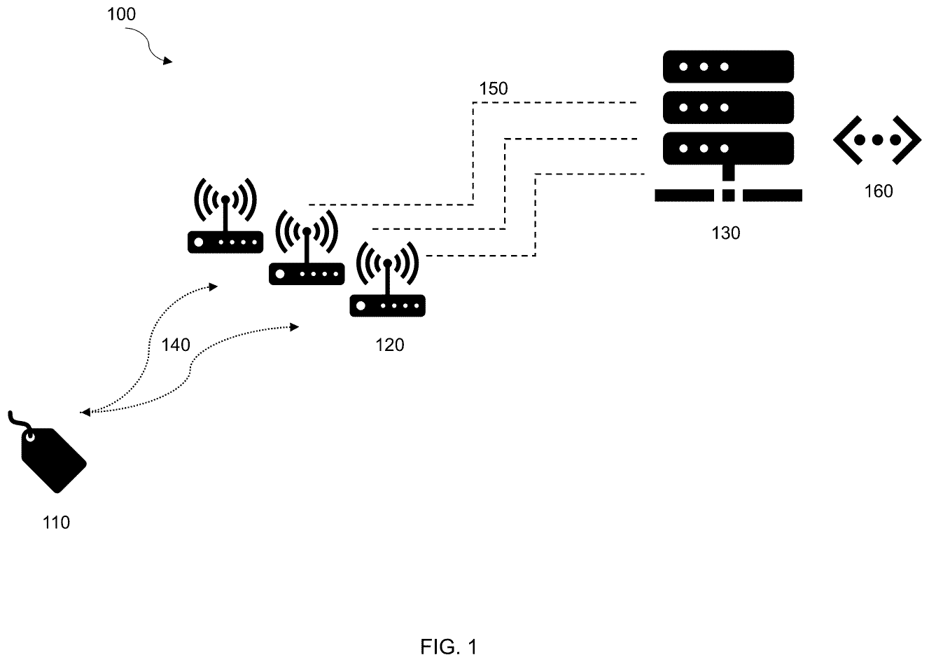

Systems and methods are disclosed for indoor positioning. Referring generally to FIGS. 1-18 systems, methods, and apparatuses for providing indoor positioning and data are illustrated. The systems and methods disclosed support robotic systems, smart device apps, local and remote computer systems for managing guest operations. A non-limiting, illustrative example of a motorized mobile chair is used throughout the disclosure. In various embodiments, a placement or location of at least one sensor may be determined based at least in part upon unique facility characteristics or other characteristics relevant to the disclosed systems and methods.

Presented herein is a real-time location system (RTLS), also referred to as an indoor positioning system (IPS), that provides spatial awareness within facilities such as hospitals, airports, warehouses, parking structures, and the like. The IPS may enable accurate tracking of assets, vehicles, and/or personnel to optimize operations and enhance navigation capabilities. In general, an asset can include anything that is trackable by the IPS, including smart phones, vehicles, carts or wheelchairs, maintenance equipment, or other operations infrastructure in the facility. Facilities may include any built structure or environment where traditional GPS is not reliable, or sufficiently accurate, for determining the position of an object or person. Facilities may include, for example, inside of buildings, parking structures, dense urban environments, inside of large ships, and underground facilities such as mines, to name a few.

### System Components

FIG. 1 depicts an embodiment of an IPS 100 according to aspects of the present disclosure composed of one or more tags 110, one or more anchors 120, and a localization server 130, among other possible components. In some implementation, the one or more tags 110 are electronic devices configured to enable accurate location determination of their position by the IPS 100 within a facility. In general, tags 110 may incorporate one or more transceivers capable of transmitting and receiving wireless signals 140 to facilitate precise spatial positioning of the tag within the facility by the IPS 100, as described in more detail below. Tags 110 may be incorporated into tracked assets in a facility (e.g. as part of the existing hardware of a smart phone) or they may be added to devices after the fact (e.g. as a separate aftermarket device). The IPS 100 may also include one or more anchors 120 which are fixed-position devices that serve as a reference point for determining the location of tags 110 within the facility. The anchor hardware may include a transceiver with specialized or unspecialized antennas configured in specific arrangements to provide optimal coverage of an area for wireless communication with tags 140. Generally, multiple anchors are located throughout a facility to create overlapping detection zones that enable detection, triangulation, or multilateration of tag 110 positions. The localization server 130, sometimes referred to as a gateway, functions as the central processing node that receives time-stamped data from distributed anchor 120 devices via wired or wireless communications 150, executes complex localization algorithms, and generates precise spatial coordinates of tags 110 within the facility environment. The localization server 130 may include a dedicated compute engine with networking capabilities that maintains synchronization between primary and secondary anchors 120, processes incoming blink packets from mobile tags 110, and applies filtering techniques such as minimum mean square error, least square error multilateration, or a similar approach to reduce measurement uncertainty in the calculated position estimates. A blink packet is a type of wireless transmission, typically used in Ultra-Wideband (UWB) indoor positioning systems, which contains identifying and timing information and is broadcast by a mobile tag 110 to be received by multiple fixed anchors for the purpose of localization. The localization server 130 also provides Application Programming Interface (API) endpoints 160 that enable robotic navigation systems, wayfinding applications, and facility management platforms to access real-time location data while maintaining secure data transmission protocols across the deployment environment. In general, an API is a set of subroutine definitions, protocols, and tools for building applications that allows for communication between various components.

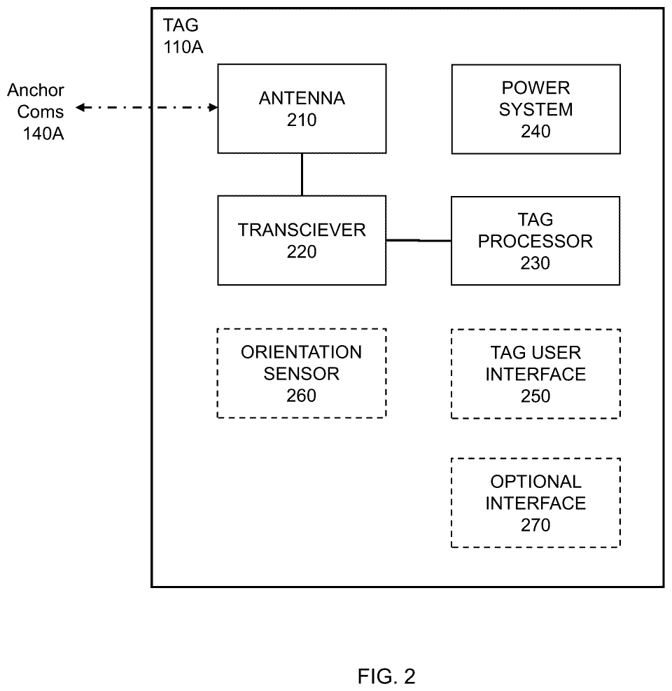

FIG. 2 depicts a physical block diagram of a tag 110A, such as that described above in IPS 100 of FIG. 1. In general, tags may be stand-alone devices or integrated directly into smart devices or robots and, in some instances, may measure approximately 63-82 mm×42-46 mm×12-13 mm and weigh around 30-35 grams in an easy to mount, robust housing. The tag 110A transmits, and may receive, signals 140A to/from one or more anchors (e.g. 120 of FIG. 1) in the facility. Signals received from the anchors 120 may be received by one or more antenna 210 for ranging and communication. In an exemplary embodiment, the tag 110A contains specialized ultra-wide-band (UWB) antennas paired with an UWB transceiver 220 designed to transmit short pulses across a wide frequency spectrum (typically in Channel 5 or 9 for interoperability with Apple® and/or Android® products and to minimize regulatory complications). A transceiver maybe hardware configured to both transmit and receive signals, wherein signals may comprise one or more of radio frequency signals, optical signals, ultrasonic signals, or other electromagnetic communications and where the transceiver may be operably coupled to one or more processors for processing signals. In one particular example, a transceiver chip which enables precise measurements with variable update rates from 10 Hz to 1 Hz may be utilized. The transceiver 220 may manage anchor communication for time-of-flight (ToF), time-difference-of-arrival (TDoA), and/or angle-of-arrival (AoA) measurements in an embodiment of the IPS 100. Additionally or alternatively, the tag 110A may include other types of antenna/transceiver pairs such as Bluetooth low energy (BLE), radio frequency identification (RFID) or other wireless communication protocols. The tag processor 230, which may host software, controls the tag's operations, including transmission timing. The processor 230 manages communications through the one or more transceivers 220 and operates onboard software related to sensor fusion, power management, motion detection and other logic. The power system 240 may include a power management integrated circuit (PMIC) or a battery power system. Battery systems may be rechargeable or non-rechargeable. The PMIC may manage power usage of the various tag functionalities as several components may require a minimum power usage. In an example, the power system 240 comprise a lithium battery with a dedicated battery management processor (BMP). For an active UWB tag, battery capacity is typically around 1000-1200 mAh, enabling up to 4-4.5 years of operation with appropriate transmission intervals. In some embodiments, one or more functions of the antenna, transceiver, processor and power system may be combined into a single component. In an exemplary embodiment, BLE may be used to enable a low-power wake-up functionality of the tag 110A so that it can enter a sleep mode and wake upon receipt of one or more BLE messages received by a BLE transceiver.

A tag 110A in some embodiments may include additional components such as a tag user interface 250, orientation sensor 260, and/or an optional interface 270. In an example, the user interface 250 of a tag 110A may be as simple as an on/off button and a light to show whether the tag is active, although more complicated interfaces are contemplated, such as any user input device for receiving inputs from a user of the tag. The addition of an orientation sensor 260 such as an inertial measurement unit (IMU) may be used to enhance the IPS system localization accuracy and to minimize power usage by the tag 110A, in some embodiments. An IMU may include one or more sensors on three axes that provide attitude information, including accelerations, yaw, pitch, and roll of the device and deviations to each. Additionally or alternatively, the tag 110A may incorporate an optional interface 270 such as Universal Serial Bus (USB) or Universal Asynchronous Receiver/Transceiver (UART) for configuration, charging, firmware updates, or direct data output.

Communication between tags and anchors 140A may, in some instances, follow specific protocols. In the UWB example, tags 110A periodically transmit short UWB pulses (“blinks”) containing data such as their unique identifier (e.g. the MAC address of the tag), the transmission time of the message, or other information. Additional data may be embedded in these pulses as well, including, but not limited to, battery status or orientation information (e.g. from an onboard orientation sensor 260). Tags 110A may be configured, by software running on the processor 230 and stored in onboard memory, with different transmission rates based on multiple factors including motion state. In one particular example, the tag 110A may blink every 1-2 seconds when in motion and every 15 minutes when static to extend battery life. In another example of software configuration of a tag, the power settings of each chirp may be adjusted based on the current orientation of the tag as sensed by an onboard orientation sensor 260.

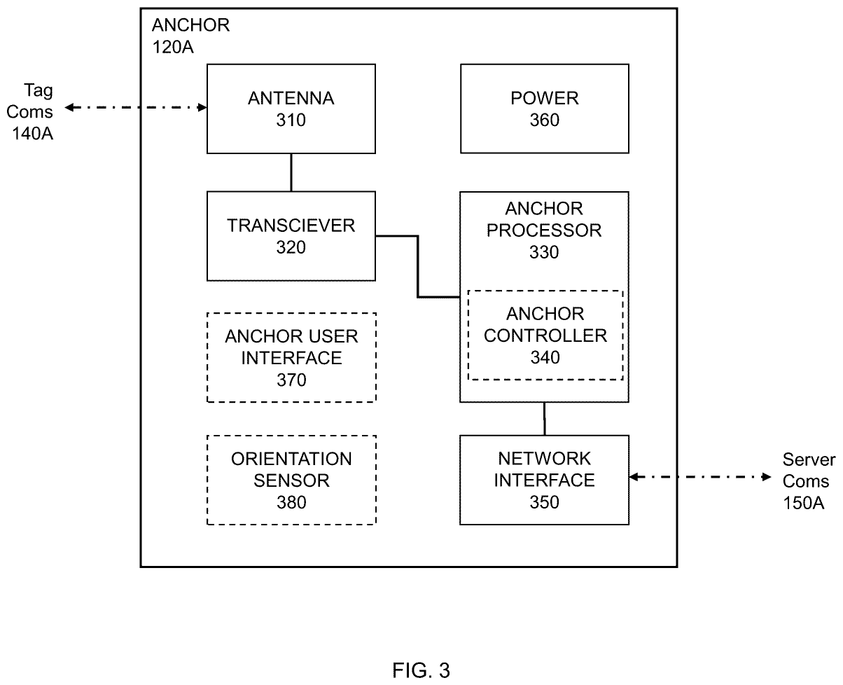

FIG. 3 depicts a physical block diagram of an anchor 120A. The anchor 120A may, in some instances, transmit and receive signals from one or more tags 110A in the facility 140A. Signals are received by one or more antenna 310 for signal transmission and reception. The number and arrangement depend on the supported operating modes of the anchor 120A (e.g. TDoA, AoA, etc). The transceiver 320 is generally responsible for transmitting and receiving radio signals (such as Ultra-Wideband pulses) used for precise ranging and localization. In an exemplary embodiment, the anchor 120A contains specialized ultra-wide-band (UWB) antennas 310 paired with an UWB transceiver 320 designed to transmit and receive short pulses across a wide frequency spectrum. Additionally or alternatively, the anchor 120A may include other types of antenna/transceiver pairs such as Bluetooth low energy (BLE), WiFi, low-power, wide area (e.g. LoRa, HaLow, etc.), radio frequency identification (RFID) or other wireless communication protocols used in combination with UWB for backhaul, data transfer, hand-shake authentication or other purposes. An anchor processor 330 (e.g. an embedded microcontroller or system-on-chip) manages signal processing, timestamping, communication protocols, and/or local computations. The network interface 340 provides connectivity to the central IPS server 150A, typically via Ethernet (often with Power over Ethernet support), WiFi HaLow, 5G, or other networking standards. In some embodiments, the network interface 340 is also used to communicate with one or more other anchors. A robust communication network between anchors 120A and the IPS server enables anchors to send timestamped data for accurate multilateration and position calculation. In some instances, anchors 120A may be powered by a power unit 360 by PoE (Power over Ethernet), but may also support DC adapters or battery operation for flexible deployment. In an exemplary embodiment, one or more of the anchor processor 330 and the network interface 340 will host a dedicated synchronization module (which may be hardware or software) that ensures time synchronization between anchors. This may be implemented via network protocols or dedicated sync signals.

An anchor 120A may, in some embodiments, include additional components such as a tag user interface 360 and/or an orientation sensor 370. In one example, the user interface 360 of an anchor 120A may be as simple as an on/off button and a light to show whether the anchor is active, although other interfaces 360 are contemplated as described above. The addition of an orientation sensor 360, such as an inertial measurement unit (IMU), can be used to enhance the IPS system localization accuracy and to automatically detect anchor misalignment or damage in some embodiments. Additionally or alternatively, one or more functions of the anchor may be accomplished by the localization server 130A.

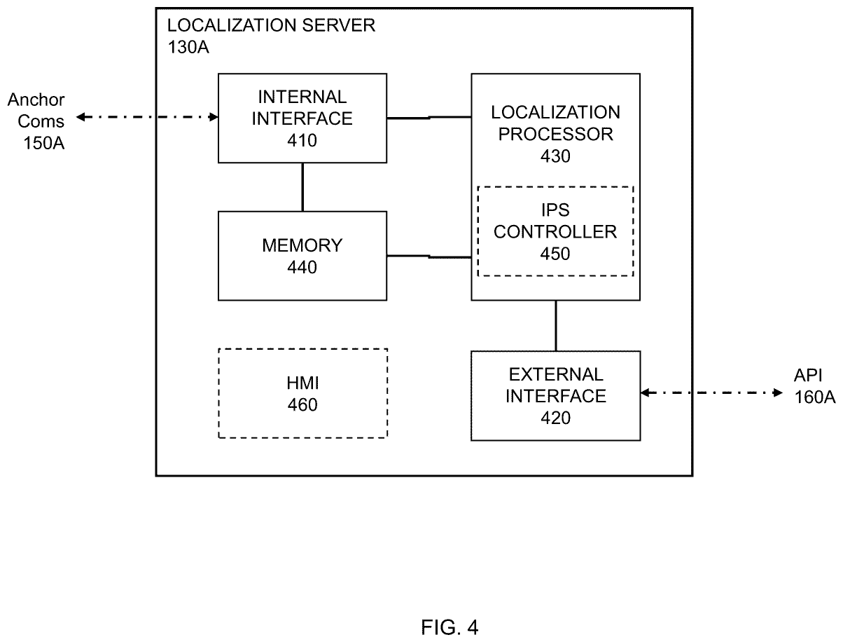

FIG. 4 depicts a physical block diagram of a localization server 130A for an IPS 100, according to one implementation. The localization server 130A receives one or more signals from one or more anchors 150A and communicates with one or more external devices via one or more APIs 160A. The localization server 130A includes an internal interface 410 to receive messages from one or more anchors 120A and an external interface 420, both of which include hardware communications interface(s). The internal and external interface components may include, in an embodiment, processors such as security processors, and may host (i.e. execute) modules and other software, such as secure abstraction APIs. Additionally or alternatively, the internal and external interface processors may host services, such as watch-dog and data source authentication services which may be used to protect one or more processors of the localization server 130A from specific software or hardware failures that may cause them to stop responding. The localization server 130A may include one or more localization processors 430 and memory 440, which are hardware. The processors may comprise one or more of a processor, multiple processors, an application-specific integrated circuit, or a field-programmable gate array. The localization processor 430 may be paired with a lock-step processor (not depicted) for life, health, and safety applications, in some embodiments. A lock-step processor may be a second processor, similar to the localization processor 430, that monitors and verifies the operation of the localization processor. Memory 440, which is typically a hardware device, may be available to all blocks in the depicted embodiment and may include volatile and non-volatile non-transitory computer storage media for storing information. The IPS controller 450 may be software that executes on one or more processors 430 on the localization server 130A and is stored in memory 440. Each processor executes software and may produce one or more control signals wherein a control signal is a wired or wireless signal, and wherein a control signal comprises one or more of a digital or an analog signal, and generally comprises or indicates data, instructions, and/or a state. Optionally, the localization server 130A may include a human machine interface 450 to visibly display server status and/or to allow interaction and configuration of the localization server through interfaces other than an API 160A. Additionally or alternatively, one or more functions of the localization server may be accomplished by the anchor 120A. In an example, the functions of the anchor and localization server may be combined on one device to allow localization of a mobile device, such as a robot or smart device.

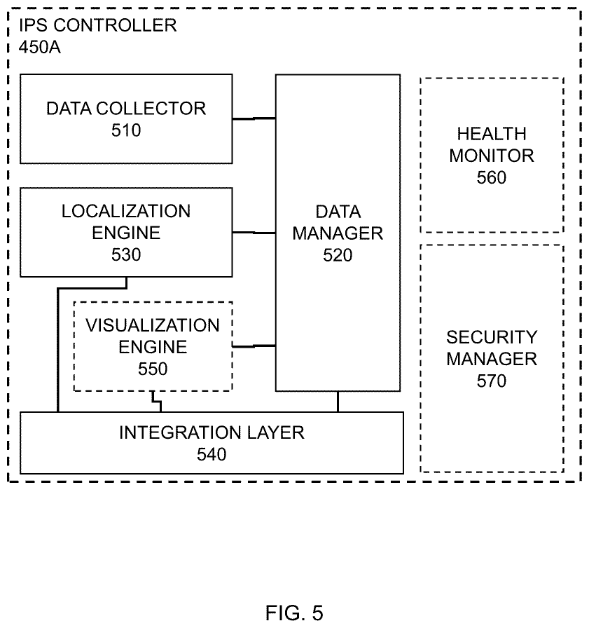

FIG. 5 depicts an embodiment of an IPS controller 450A that may be deployed as logic or as a hardware component in the architecture described by FIG. 4. The IPS controller 450A is comprised, in some instances, of a data collector 510, data manager 520, localization engine 530, and an integration layer 540. Additionally, some embodiments, a visualization engine 550, a health monitor 560, and a security manager 570 may be included. These components may collectively enable an IPS controller 450A to deliver accurate, real-time indoor positioning, support integration with other systems, while ensuring operational reliability and security of the IPS.

In general, the data collector 510 aggregates and/or transmits received data to the data manager 520. The data manager 520 may, in turn, store location data, maps, and system configurations for use by other IPS controller processes. The data manager 520 may store real-time and historical location data, system configurations, and reference point information for use by other system processes. Additionally, the data manager 520 maintains facility maps, anchor locations, and floor plans used by the localization engine 530 and visualization engine 550 to contextualize position data.

The localization engine 530 may execute one or more algorithms to estimate tag positions. In some instances, the localization engine 530 estimates device locations using algorithms such as:
Trilateration/Triangulation to calculate position based on distances from multiple reference points.
Fingerprinting to match real-time signal characteristics to a pre-recorded map of signal signatures.
Time of Arrival (ToA)/Time Difference of Arrival (TDoA) utilizing timing information for high-accuracy positioning (common in UWB systems).
Dead Reckoning: Uses sensor data (e.g., accelerometers, gyroscopes) to estimate movement between known positions
   Generally speaking, none of the above techniques alone can create reliable, accurate position data in large, crowded facilities. Rather, multipath effects degrade accuracy in these crowded environments requiring the use of advanced filtering techniques, such as Kalman filters and sensor fusion techniques like those described in this document, for success.

The integration layer 540 enables external access and integration with third-party systems. The integration layer provides interfaces (REST, WebSocket, etc.) for external systems (e.g., mobile apps, dashboards, robots) to access real-time and historical location data. Additionally or alternatively, the integration layer 540 connects with third-party systems (e.g., ERP, CRM, security systems) and supports data exchange and event triggers.

The visualization engine 550 visualizes location data and system status for users and administrators to allow for monitoring live locations, analysis of historical movement, management of users, and configuration of the system. In one embodiment, the visualization engine 550 may present location information to end-users and support navigation, notifications, and alerts.

The health monitor 560 monitors and reports on the operational status of system components by tracking the operational status of anchors, tags, and the server, providing alerts and diagnostics for maintenance and troubleshooting

The security manager 570 of the IPS controller 450A protects data integrity, privacy, and manages user access. It ensures secure transmission and storage of sensitive location data. The security manager may also manage user roles and permissions for data access and system configuration.

### Frames of Reference

The localization engine 530, in some embodiments, operates in a uniform way at a systems level with all the tags, anchors, data, time, etc. coordinated into a unified system. Some difficulties in uniform operations include that reports from the system components are typically in local coordinates, that the system components are mounted at distributed points on and around the facility to achieve the best fields of view, and that processing time, update rate, communications time, and other operating parameters may vary with each component. The frames of reference for each component can be identified and described in terms of their relationship to each other and their functional roles. These difficulties may be overcome using one or more of the following methods.

Generally speaking, there may be five frames of reference in an IPS system (although other frames of references may be contemplated and utilized). These general frames of reference include:
1. Asset/Tag Frame.
2. Anchor Frame.
3. Facility Frame.
4. Earth Frame.
5. Geo Frame.

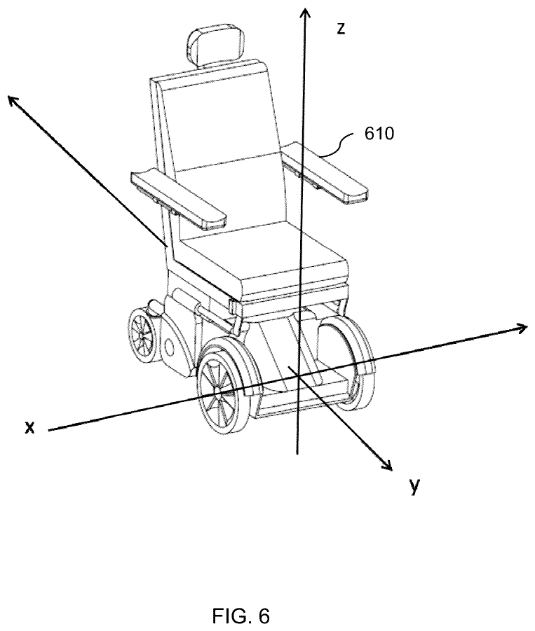

In some instances, an asset or tag frame extends from the center of the antenna (e.g. 210 FIG. 2) of the tag 110A but can be defined as any arbitrary point on the asset or tag. FIG. 6 depicts a robotic vehicle with an integrated tag device 110A for use in an example IPS 100. In the depicted embodiment, the x-axis extends from left to right of the robotic vehicle 610 and is parallel to the front of the robotic vehicle, the y-axis is perpendicular to the x-axis extending forward in the direction of travel, and the z-axis is orthogonal to the x and y-axis and vertical through the intersection of the x and y axes. The x, y, and z-axes represent roll, pitch, and yaw measurements.

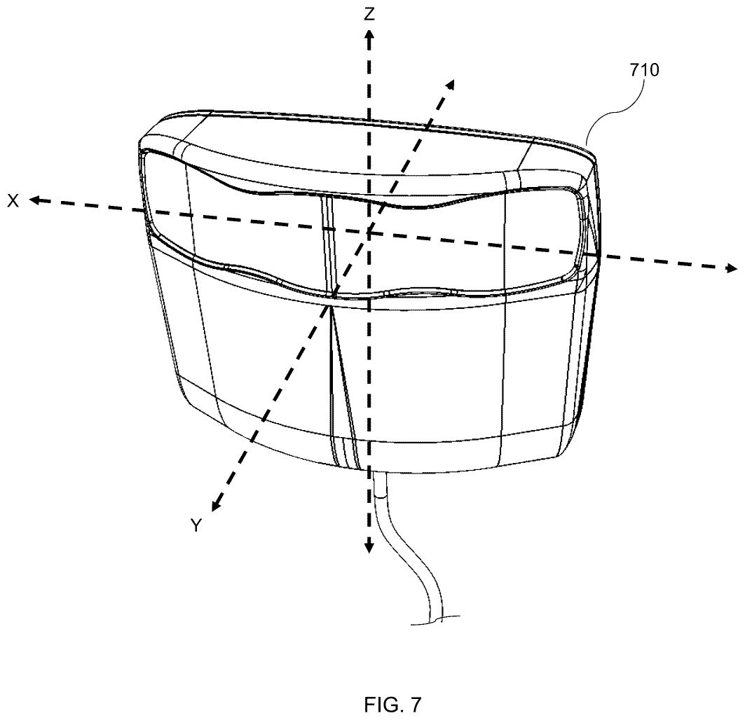

FIG. 7 depicts an exemplary anchor 710 frame of reference. In the depicted embodiment, the x-axis extends from left to right of the anchor housing and is parallel to the front of the anchor, the y-axis is perpendicular to the x-axis extending forward, and the z-axis is orthogonal to the x and y-axis and vertical through the intersection of the x and y axes. As with the asset reference frames, x, y, and z-axes represent roll, pitch, and yaw measurements.

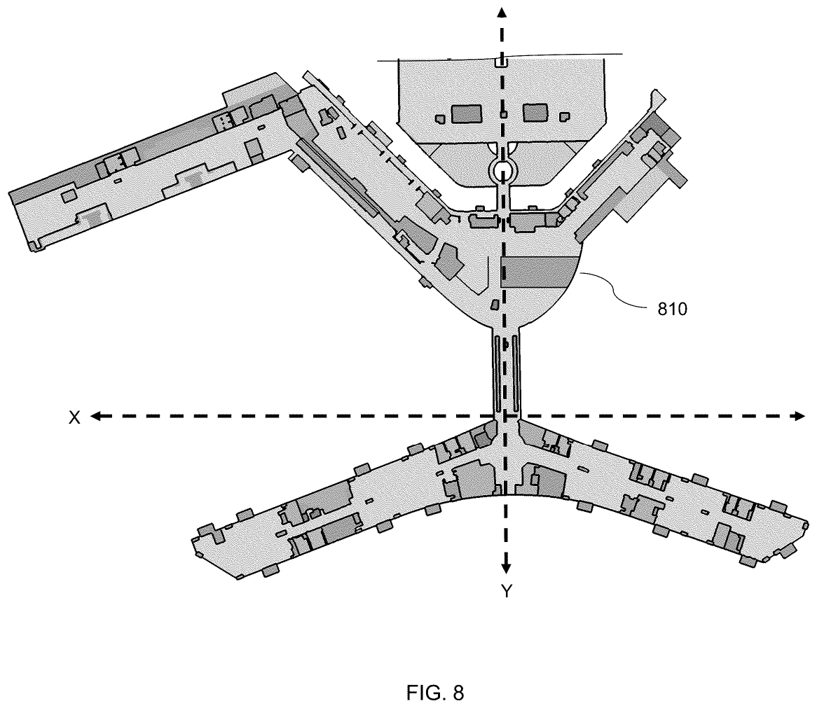

FIG. 8 depicts an exemplary facility frame of reference overlaid on a floorplan of a building 810 or other interior area. The facility frame of reference generally relates to how data consumers (e.g. robots, wayfinding applications, and users) traveling in the environment navigate the facility. In this frame of reference, the z-coordinate becomes related to which floor of the building an object is located. One purpose of the localization engine 530 of the localization server 130A is to calculate the accurate, real-time location of assets (e.g. tags 110) in the facility frame of reference for use by one or more external processes where the one or more external processes access the one or more asset locations via an API 160A.

The next two frames of reference are the earth frame and geo frame. The earth frame is in terms of latitude, longitude, and altitude as represented on a map. The geo frame is earth centered and earth fixed in terms of direction cosines. The intersection of these curved lines from the center of the earth represent where an object is located three dimensionally above or below the surface of the earth, as when traveling in an airplane or submarine. These two terms are sometimes referred to as the geoid and spheroid. Use of the geo frame and earth frame may be useful for navigating between floors on a multi-story building and therefore, in an embodiment, the localization engine 530 of the localization server 130A may additionally or alternatively calculate the accurate, real-time location of assets (e.g. tags 110) in the earth or geo frames of reference for use by one or more external processes where the one or more external processes access the one or more asset locations via an API 160A.

### Establishing a Uniform Map

With focus on the first four frames of reference, a uniform method of receiving, using, and sharing information may be established by the IPS system 100. Tag data (140, FIG. 1), anchor data (150, FIG. 1) and/or external data (160, FIG. 1) may be received by the IPS controller 450 relative to different frames of reference. A method for managing the different frames of references of the data may include establishing a uniform Cartesian coordinate system extending from the facility 810 reference frame depicted in FIG. 8. Data received by the IPS controller 450 may be translated to the facility 810 reference frame, where the earth reference frame may also be referenced to the facility 810 reference frame by the localization engine 530. Any anchor data received in polar coordinates (i.e. range and bearing to objects) are first translated into Cartesian coordinates by the localization engine 530 through a standard conversion. Then, the converted data may be translated by the localization engine 530 into the facility 810 reference frame and related to the earth frame.

The use of a single uniform Cartesian grid (UCG) facility frame of reference lays the foundation for creating a virtual situational awareness (SA), or tactical, map. The situational awareness map comprises objects, the kinematic states of these objects, and state propagation with respect to the facility map and the objects in the environment. The map is constantly updating with data reported by anchors (see FIG. 1) and data reported by remote services via one or more API 160. The map may be maintained by the localization engine 530 and/or visualization engine 550 of the IPS controller 450A and allows the localization server 130A to calculate the location of objects. The UCG becomes the single corrected frame of reference for all calculations on the IPS controller 450.

The IPS system 100, as disclosed, uses tags and anchors capable of making measurements with a minimal amount of error, or variance. Variance may be defined in terms of plus or minus in seconds, milliseconds, feet, inches, yards, degrees, radians, etc. Measurements are used in support of a logic based IPS controller 450 that may be inferenced by some form of adaptive learning that operates like intuition. Two or more anchor reports on the same tag that are different and can be associated in time may be combined to generate a better report, with the goal of improving confidence in the IPS map. There are multiple methods of combining anchor reports (e.g. time difference of arrival and angle of arrival) and controlling tag to anchor interactions (e.g. uplink, downlink, and two-way ranging).

### Time Difference of Arrival

Time Difference of Arrival (TDoA) is one method for calculating the location of one or more tags within a facility. In TDoA systems, referencing the hardware of FIG. 1, tags 110 may periodically transmit “blink” packets containing tag identification information (e.g. MAC address) and potentially other data. These transmissions are received by multiple anchors 120 within range, with each anchor recording the precise time of signal reception. The anchors 120 may provide the time of arrival of the transmission to the localization server 130 which, in turn, may use this information from the anchors to determine the location of the transmitting tag in the facility. TDoA utilizes the time differential between signal receptions at multiple anchors to calculate the position of a uniquely identified transmitting tag. In TDoA based systems, the fundamental principle involves measuring the time differences between the arrival of a signal transmitted by a tag at multiple fixed anchor points. These time differences create hyperbolic curves with the interaction of these curves determining the tag's position in two-dimensional or three-dimensional space. Therefore, multiple anchors receive the tag transmission for TDoA to method to determine the tag location, with three anchors providing accurate 2D location and four anchors typically required for 3D location.

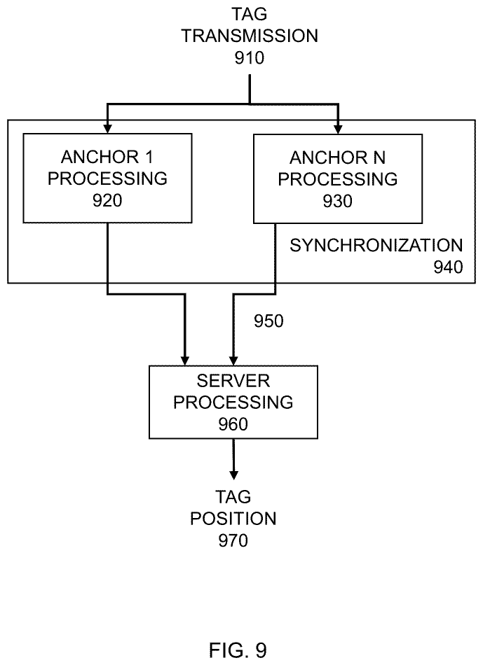

FIG. 9 depicts an example functional flow diagram of TDoA localization that may be utilized by the IPS 100 described herein. In the example, a wireless transceiver of a tag (e.g. 220 FIG. 2) is configured to transmit one or more signals containing data 910. The one or more signal from the tag 910 are received by the wireless transceivers of an anchor (e.g. 320 of FIG. 3). Two or more anchors receive the signal containing data 910 from the tag. Each receiving anchor is equipped with receivers capable of detecting wireless signals from tags and processing the signal 920, 930 to precisely timestamp their arrival.

An aspect of the TDoA systems is the synchronization mechanism 940 that allows for accurate time difference calculations. In particular, the anchors (i.e. 920 and 930 in the example) may maintain precisely synchronized clocks. This synchronization is typically achieved through a primary-secondary architecture, where designated primary anchors (e.g. anchor 1) transmit synchronization messages to secondary anchors (e.g. anchor 2). The synchronization message may include the anchor ID, time of transmission, and in some architectures where sync messages are passed along also a time of receipt. The synchronization process ensures that time measurements across all anchors share a common reference clock.

The processed, and synchronized, data from each anchor is then transmitted to the localization server 950 where data for each received tag message is communicated with its time of reception, unique ID, and/or anchor role (e.g. primary or secondary). Additionally, one or more synchronization message may be communicated with the localization server 950 over the network interface. In an example, the anchor 120A transmits the information via a network interface 350 to the internal interface 410 of the localization server 130A for processing by the IPS controller 450.

The internal interface 410 of the localization server 130A receives raw data from anchors, including reception timestamps and, in some embodiments, signal characteristics such as Received Signal Strength Indicator (RSSI) and Phase Difference of Arrival (PDoA) measurements. The IPS controller 450 (which may be executed by the localization processor 430) processes the raw data from the internal interface 410, as well as parameters, programs and historical information from memory 440, to extract relevant information for position calculation of the tag, including time differences between signal receptions at different anchors.

The localization processor 430 represents the central processing unit of the exemplary TDoA system. It receives processed data from anchors via the communications network and executes the algorithms to calculate tag positions. The server 130A maintains a database of anchor locations and performs the mathematical calculations required to determine tag coordinates based on time difference measurements.

In some instances, the mathematical calculation of TDoA positioning relies on hyperbolic multilateration. When a tag transmits a signal, the difference in arrival time between any pair of anchors defines a hyperbola (in 2D) or hyperboloid (in 3D) representing all possible positions where the tag could be located. With measurements from at least three anchors (for 2D positioning) or four anchors (for 3D positioning), the intersection of these hyperbolas or hyperboloids determines the tag's position.

The time difference between signal reception at two anchors can be expressed as:

$$Δ {t}_{ij} = {t}_{i} - {t}_{j} \qquad Eqn 1$$

Where tᵢ and tⱼ are the reception times at anchors i and j, respectively.

This time difference corresponds to a distance difference:

$$Δ {d}_{ij} = c \cdot Δ {t}_{ij} \qquad Eqn 2$$

Where c is the speed of light.
The set of points satisfying this distance difference forms a hyperbola (in 2D) or hyperboloid (in 3D) with foci at the positions of anchors i and j. This calculation may be repeated for multipipe tags to determine and track the tag position. Additionally or alternatively, the change in position over time may be used to calculate an estimated kinematic state of each tag.

TDoA systems can be configured to operate in two distinct configurations: uplink TDoA and downlink TDoA. Both approaches utilize similar hardware components but with inverted roles and signal flow directions, resulting in different system characteristics particularly regarding scalability, power consumption, and deployment considerations. The previous example, referencing FIG. 9, was focused on uplink TDoA configuration where fixed anchors in the facility track one or more mobile tag.

Uplink TDoA has the benefits of tag simplicity, centralized computational resources, and scalability. In uplink TDoA, tags only need to transmit simple blink packets periodically, making them lightweight, inexpensive, and low power. Additionally, by consolidating position calculations on the infrastructure side (anchors and server) and not on the tag, the need for distributed compute is eliminated. This may result in a lower overall system cost, allowing the system to track numerous tags simultaneously as tags merely transmit signals without receiving or processing data.

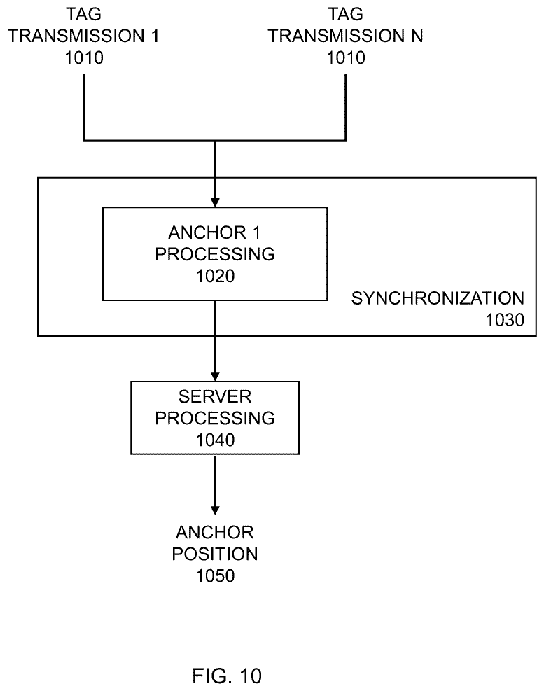

In downlink TDoA (also called untracked TDoA), the positioning process is inverted. FIG. 10 depicts an example functional flow diagram of downlink TDoA localization. The fixed “tags” (which have the physical architecture of FIG. 2) transmit synchronized blink messages from known locations that are received by the mobile “anchors” (which have the physical architecture of FIG. 3). The anchor listens for these blinks from multiple fixed tags and uses the time-of-flight (ToF) differences from the multiple tags to triangulate its own position relative to the known locations of the tags. In some embodiments, the mobile device may incorporate the functions of both the previously disclosed anchor of FIG. 3 and the localization server of FIG. 4. The benefits of downlink TDoA include:
Theoretically infinite number of tags can be supported since anchors broadcast signals regardless of how many tags are listening.
Downlink TDoA aligns with emerging standards for smartphone integration, particularly with Apple's U2 UWB chip now available in iPhone® 15.
For applications requiring guest wayfinding in large facilities, downlink TDoA may be preferred as it enables users' personal devices to determine their own locations without requiring specialized tags.

Both uplink and downlink TDoA utilize the same general hardware components but with inverted roles:

| | |
|---|---|
| Anchors | In uplink TDoA: Anchors function primarily as receivers, |
| | capturing tag transmissions and forwarding timestamps to the |
| | server. |
| | In downlink TDoA: Anchors function primarily as transmitters, |
| | sending synchronized signals to be received by tags. |
| Tags | In uplink TDoA: Tags function as transmitters only, sending blink |
| | packets without needing to receive or process data. |
| | In downlink TDoA: Tags function as receivers and processors, |
| | capturing anchor signals and calculating their own positions. |
| Synchronization | Both systems require precise time synchronization between |
| | anchors, typically through a master-slave architecture1. |
| | The synchronization mechanism remains similar in both |
| | approaches, but the direction of the primary positioning data flow |
| | is inverted. |
| Localization Server | In uplink TDoA: The server receives timestamps from anchors |
| | and performs position calculations1. |
| | In downlink TDoA: The server's role in position calculation is |
| | reduced or eliminated, as tags calculate their own positions. |

### Angle of Arrival

Angle of arrival (AoA) processing refers to the determination of the angle at which a signal arrives at a receiving antenna array. The AoA processing comprises several functional components that work in concert to determine the precise angle of signal arrival. AoA may be combined with simple two-way ranging systems to calculate a 2D or 3D location for the source of a signal.

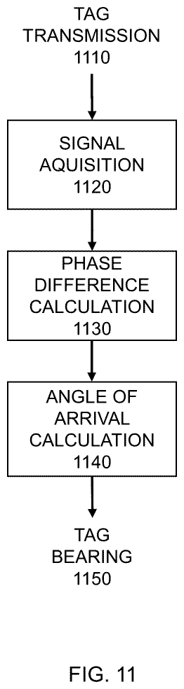

FIG. 11 depicts a functional block diagram of an AoA calculation. In this embodiment, the anchor receives signals transmitted by tags 1110 through an antenna array. The antenna array typically comprises multiple antenna elements arranged in a specific geometry to enable phase difference measurements (e.g., linear, L-shaped, or toric arrays). In UWB systems, the anchor transceiver (e.g. 320 of FIG. 3) processes the incoming blink packets from tags and prepares them for processing. Synchronization of time, frequency, and phase across all antennas is essential for accurate AoA estimation. The process of receiving the signals and preparing them for processing considered signal acquisition 1120.

Once signals are acquired, the transceiver (or anchor processor in some embodiments) measures the phase differences between signals received at different antenna elements 1130. These phase differences are directly related to the angle at which the signal arrives at the antenna array. The module processes the raw signal data to extract precise timing information and calculate phase differences between antenna pairs. The core mathematical principle is that a wavefront arriving at an array will reach each antenna at slightly different times, resulting in measurable phase or time differences. For two antenna elements of an anchor separated by distance d, the angle (azimuth or elevation) can be estimated using:

$$θ = {sin}^{- 1} ( \frac{c \cdot Δ t}{d} ) \qquad Eqn 3$$

Where c is the speed of light and delta-t is the time difference of arrival at the two separate antenna elements. Alternatively, this can be written using a phase difference (delta-phi) shown in Equation 4.

$$θ = {sin}^{- 1} ( \frac{λ \cdot Δϕ}{2 π d} ) \qquad Eqn 4$$

Where lambda is the wavelength of the received signal.

Using the measured phase differences, the module calculates the azimuth and elevation angles of the incoming signal. Both azimuth and elevation can be estimated by solving a system of equations relating the observed phase differences to the geometry of the array. For multi-element antenna arrays, more advanced signal processing algorithms may be used to estimate of the azimuth and/or elevation such as phase correlation, energy detection, or ESPIRIT and MUSIC techniques. Additionally, one or more filtering methods may be used to clean the calculated angles such as regression filtering and Kalman filtering.

Given the calculated angle of the incoming signal, the position of the tag can then be determined from the received angle. The calculation applies trigonometric principles based on the known geometry of the antenna array. In an example, with a known anchor height and estimated floor levels for a tag, for an anchor at position (x₀, y₀, z₀) observing a tag at angle θ, the relationship between the tag's position and the observed angle can be expressed as:

$$y = ( x - {x}_{0} ) tan ( θ ) + {y}_{0} = x tan θ - {x}_{0} tan θ + {y}_{0} \qquad Eqn 4$$

The module produces angular measurements along with a Figure of Merit (FOM) that indicates the confidence level of the angular measurement.

### TDoAoA FUSION

Regardless of configuration, an IPS 100 utilizing TDoA may struggle in complex environments, particularly due to multipath interference. This phenomenon occurs when signals travel via multiple paths to reach receivers, creating signal reflections that can significantly degrade positioning accuracy. In indoor environments, UWB signals may encounter numerous reflective surfaces including walls, floors, ceilings, and various objects. These reflections create multiple signal paths between transmitters and receivers, resulting in:
Time measurement errors-Reflected signals arrive later than direct path signals
Phase distortion-Signal phase becomes corrupted by overlapping reflections
   These issues are particularly problematic in narrow corridors and areas with complex architectural features. What is needed is a more robust way of calculating the location of tracked assets (i.e. tags) while also requiring less installed infrastructure in the facility (i.e. anchors).

An exemplary implementation of TDoA to address these issues incorporates Angle of Arrival (AoA) measurements. For the purposes of explanation this approach is referred to as TDoAoA herein. In this approach, anchors not only record signal reception times but also have antenna arrays configured such that they can measure the angle at which signals arrive at the anchors. By combining time difference data with angle measurements, the IPS system 100 can achieve improved positioning accuracy with fewer anchors, particularly in challenging environments such as narrow corridors. Through the TDoAoA process, a pair of anchors providing a time difference reading produces one hyperbola of possible tag locations. The angles measured by each anchor further constrain the possible positions to the points where these angle lines intersect the hyperbola, significantly reducing positioning ambiguity and therefore providing similar locational accuracy with less infrastructure.

An exemplary TDoAoA calculation where two anchors at different, known locations receiving a signal from a tag at a third position with coordinates (x, y, z) is now described. For any two anchors positioned at coordinates (xₒ, yₒ, zₒ) and (x₁, y₁, z₁) respectively, the basic time difference of arrival calculation, as previously disclosed, can be expressed mathematically as:

$$SQRT ( {( x - {x}_{1} )}^{2} + {( y - {y}_{1} )}^{2} + {( z - {z}_{1} )}^{2} ) - SQRT ( {( x - {x}_{0} )}^{2} + {( y - {y}_{0} )}^{2} + {( z - {z}_{0} )}^{2} ) = C ( {t}_{1} - {t}_{0} ) \qquad Eqn . 5$$

### Where:

(x, y, z) represents the unknown position of the tag.
(x₀, y₀, z₀) and (x₁, y₁, z₁) are the known positions of the anchors.
t₀ and t₁ are the times at which the signal is received at each respective anchor
is the speed of signal propagation (typically the speed of light for radio frequency signals)
   This equation defines the hyperboloid of possible positions for the tag seen by two anchors. With measurements from additional anchors, multiple hyperboloids can be generated, and the tag's position could be determined by the intersection of these hyperboloids.

The Angle of Arrival methodology complements TDoA by incorporating angular measurements. When anchors observe the angle of arrival of a signal from a tag, this information can be used to further constrain the possible positions of the tag on the hyperboloids. For an anchor at position (x₀, y₀, z₀) observing a tag at angle θₐ, the relationship between the tag's position and the observed angle can be expressed as:

$$( x - {x}_{0} ) tan ( {θ}_{a} ) = ( y - {y}_{0} ) \qquad Eqn . 6$$

Similarly, for a second anchor at a different position (x₁, y₁, z₁) observing the same tag at a different angle θ_{b}:

$$( x - {x}_{1} ) tan ( {θ}_{b} ) = ( y - {y}_{1} ) \qquad Eqn . 7$$

If we assume the tag is at a known height z. These equations constrain the possible positions of the tag to a line in the x-y plane. Alternatively, the z height may be calculated using a similar approach in some embodiments.

With both TDoA and AoA measurements available, a more accurate position estimation can be calculated for the tag. The combination of these techniques in TDoAoA provides redundant information that can be fused to improve positioning accuracy and reduce uncertainty. In a simplified example for clarity of explanation; for a known tag height relative each anchor (z₁* and z₀* respectively) the previously disclosed equations can be combined to:

$$SQRT ( {( x - {x}_{1} )}^{2} + {( ( x - {x}_{1} ) tan ( {θ}_{b} ) )}^{2} + {{z}_{1 *}}^{2} ) - SQRT ( {( x - {x}_{0} )}^{2} + {( ( x - {x}_{0} ) tan ( {θ}_{a} ) )}^{2} + {{z}_{0 *}}^{2} ) = C ( {t}_{1} - {t}_{0} ) \qquad Eqn . 8$$

Equation 8 cannot be solved directly for x in closed form such that the solution requires numerical methods. These methods may include the Newton-Raphson method, the Bisection method, or an extended Kalman filter as examples. In an exemplary embodiment, Equation 7 is solved as part of a state estimation calculation using an Extended Kalman Filter, which recursively processes measurements to estimate the state (position) of the tag. Additionally or alternatively, this equation would be combined with additional measurements from other anchors to form a system of equations that can be solved to determine the complete position (x, y, z) of the tag.

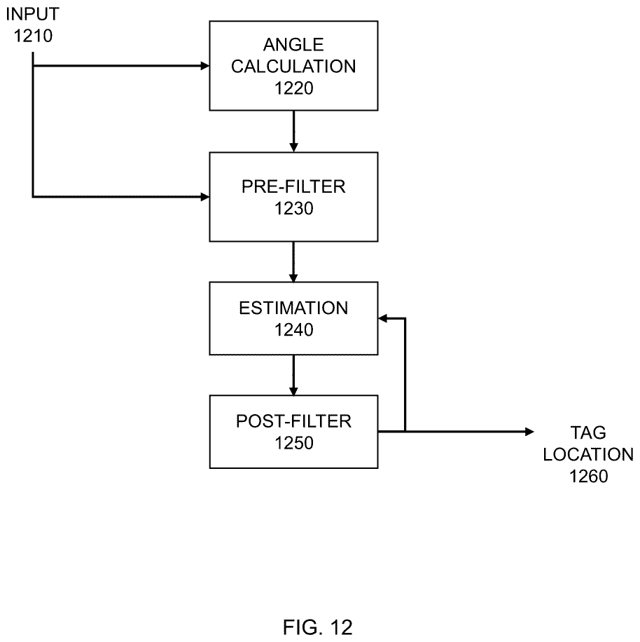

FIG. 12 depicts an exemplary TDoAoA process used to calculate the position of a tag of the IPS 100. In particular, the process may be executed by an embodiment as part of the IPS controller 450 of the localization processor 450. The exemplary process takes in one or more inputs 1210 and outputs an estimated tag location 1260 for a given tag. The one or more inputs 1210 of the process may include, in the example, phase difference and/or angle of arrival data and time of arrival data. The process comprises angle calculation 1220, pre-filtering 1230, estimation 1240, and post filtering 1250 steps. The angle calculation step 1220 refers to the previously disclosed process of measuring the phase differences between signals received at different antenna elements on an anchor. In an embodiment, the anchor processor 330 of the anchor receives the phase differences between antenna pairs from one or more transceivers (e.g. 320) of the anchor and communicates, via a network interface 350 to the localization server 130A. The phase differences between antenna pairs may be used, by the IPS controller 450, to calculate the angle of arrival (e.g. using Eqn. 3). Additionally, or alternatively the angle calculation step may be completed on the anchor transceiver, anchor processor, or other location in the system and provided directly to the TDoAoA process.

The pre-filter 1230 receives the time of arrival data from two or more anchors and the calculated angle of arrival data from one or more anchors from the previous step of the process and utilizes one or more filters to clean the data. For example, a pre-filter may include basic bounding filters, temporal filters, low-pass filters, weighted average filters, or any other preconditioning processes to lower measurement noise in the system. In an exemplary embodiment, the preconditioning filter applies a rules-based filter to remove or correct readings that are outside of an upper and/or lower bound. For example, if each of the received calculated angle of arrival values are outside the potential measured angle of arrival of an anchor, then the value may be set to null.

The filtered data is then used by estimation 1240. In an exemplary embodiment, estimation is done with an extended Kalman filter (EKF). The EKF recursively processes measurements to estimate the state of the tag, including its position and velocity. The state vector for the EKF is defined as:

$$χ = {[ x , {v}_{x} , y , {v}_{y} , z , {v}_{z} ]}^{T} \qquad Eqn . 9$$

Where x, y, z represent the position coordinates and vₓ, v_{y}, and v_{z} represent the velocity components in each dimension.

To calculate the estimate using the EKF, a matrix of partial derivatives called the Jacobian may be used. The Jacobian is used by each step of the EKF to create an estimate. The Jacobian for TDoAoA is the partial derivatives of each measurement value for each state value. The measurement values are the time difference of arrival, angle of arrival or azimuth, and elevation. The state values are the x, y, and z position of the anchor whose location received the measurement values. The state also comprises velocity variables, however for most implementations of TDoAoA, the acceleration can be assumed zero. Equations 10 thru 12 noted below are the reference coordinates for an anchor in the facility (e.g. FIG. 8) or global frame of reference where t is the anchor translation and r is the anchor rotation as a quaternion.

$${x}_{1} ( x , y , z ) = {a}_{x} ( x - {t}_{x} ) + {b}_{x} ( y - {t}_{y} ) + {c}_{x} ( z - {t}_{z} ) \qquad Eqn . 10$$

$$Where :$$

$${a}_{x} = {r}_{w}^{2} + {r}_{x}^{2} - {r}_{y}^{2} - {r}_{z}^{2}$$

$${b}_{x} = 2 ( {r}_{w} {r}_{z} + {r}_{x} {r}_{y} )$$

$${c}_{x} = 2 ( {r}_{x} {r}_{z} - {r}_{w} {r}_{y} )$$

$${y}_{1} ( x , y , z ) = {a}_{y} ( x - {t}_{x} ) + {b}_{y} ( y - {t}_{y} ) + {c}_{y} ( z - {t}_{z} ) \qquad Eqn . 11$$

$$Where :$$

$${a}_{y} = 2 ( {r}_{y} {r}_{x} - {r}_{w} {r}_{z} )$$

$${b}_{y} = {r}_{w}^{2} - {r}_{x}^{2} + {r}_{y}^{2} - {r}_{z}^{2}$$

$${c}_{y} = 2 ( {r}_{w} {r}_{x} + {r}_{y} {r}_{z} )$$

$${z}_{1} ( x , y , z ) = {a}_{z} ( x - {t}_{x} ) + {b}_{z} ( y - {t}_{y} ) + {c}_{z} ( z - {t}_{z} ) \qquad Eqn . 12$$

$$Where :$$

$${a}_{z} = 2 ( {r}_{w} {r}_{y} + {r}_{x} {r}_{z} )$$

$${b}_{z} = 2 ( {r}_{y} {r}_{z} - {r}_{x} {r}_{w} )$$

$${c}_{z} = {r}_{w}^{2} - {r}_{x}^{2} - {r}_{y}^{2} + {r}_{z}^{2}$$

Values can be converted from cartesian to spherical coordinates given:

$$ρ ( x , y , z ) = \sqrt{{x}^{2} + {y}^{2} + {z}^{2}} \qquad Eqn . 13$$

$$θ ( x , y , z ) = {tan}^{- 1} ( \frac{y}{x} ) \qquad Eqn . 14$$

$$ϕ ( x , y , z ) = {cos}^{- 1} ( \frac{z}{ρ ( x , y , z )} ) \qquad Eqn . 15$$

Combining the above, partials for each coordinate can be derived. The partials for x are shown below. For y and z partials, simply swap the constants for b and c respectively.

$$\frac{\partial ρ}{\partial x} = \frac{{a}_{x} {x}_{1} ( x ) + {a}_{y} {y}_{1} ( x ) + {a}_{z} {z}_{1} ( x )}{\sqrt{{{x}_{1} ( x )}^{2} + {{y}_{1} ( x )}^{2} + {{z}_{1} ( x )}^{2}}} \qquad Eqn . 16$$

$$\frac{\partial θ}{\partial x} = \frac{{a}_{y} {x}_{1} ( x ) - {a}_{z} {y}_{1} ( x )}{{{x}_{1} ( x )}^{2} + {{y}_{1} ( x )}^{2}} \qquad Eqn . 17$$

$$\frac{\partial ϕ}{\partial x} = \frac{{ρ}^{′} ( x ) {z}_{1} ( x ) - {a}_{z} ρ ( x )}{\sqrt{1 - {( \frac{{z}_{1} ( x )}{ρ ( x )} )}^{2}}} \qquad Eqn . 18$$

The partial derivatives for each coordinate are now combined into the total Jacobian matrix for the estimation function as shown in the matrix below.

$$[ \begin{matrix}\frac{\partial ρ}{\partial x} - \frac{\partial {ρ}_{m}}{\partial x} & 0 & \frac{\partial {ρ}_{x}}{\partial y} - \frac{\partial {ρ}_{m}}{\partial y} & 0 & \frac{\partial {ρ}_{x}}{\partial z} - \frac{\partial {ρ}_{m}}{\partial z} & 0 \\ \frac{\partial θ}{\partial x} & 0 & \frac{\partial θ}{\partial y} & 0 & \frac{\partial θ}{\partial z} & 0 \\ \frac{\partial ϕ}{\partial x} & 0 & \frac{\partial ϕ}{\partial y} & 0 & \frac{\partial ϕ}{\partial z} & 0\end{matrix} ] \qquad Eqn . 19$$

The above Jacobian (Eqn. 19), can then be used to fuse time and angle of arrival data from two or more anchors to determine the position of a tag at the estimation step 1240.

The post filter 1240 receives the time of arrival data from two or more anchors and the calculated angle of arrival data from one or more anchors from the previous step of the process and apply one or more filters to clean the data. The post filter 1240 may also receive the estimated tag location from the previous step of the process and may use one or more filters to the received location data. In one example, the post-filter may include rules-based filters, temporal filters, or any other post conditioning steps necessary to reduce noise in the system. In an exemplary embodiment, the post conditioning filter applies a rules-based filter to remove or correct readings that are outside of reasonable bounds. For example, if all tracked objects are people, there are reasonable speeds of travel that limit potential updates to a tag location. In another example, if an estimated location received by the post filter 1240 is outside of an area of the facility map that is accessible to people, the filter may move the location to the closest available position of accessible are at the facility.

After filtering, the estimated tag location 1260 of the TDoAoA process can be used by one or more other process (e.g. of the IPS controller 450A). The TDoAoA process is repeated for each tag being tracked in the facility.

As such, some implementations of the present disclosure may include a method for locating a device in an indoor facility. The method may include the operations of transmitting, by a first transceiver to a second transceiver and a third transceiver, a first signal, determining, by a processor, a first TDoA and a first AoA of the first signal based on the second transceiver receiving the first signal, and determining, by the processor, a second TDoA and second AoA of the first signal based on the third transceiver receiving the first signal. The method may further include the operations of calculating, based on the first TDoA, the first AoA, the second TDoA, and the second AoA, an estimated location of the first transceiver in relation to an anchor device and calculating, based on the first TDoA, the first AoA, the second TDoA, and the second AoA, an estimated uncertainty of the location of the first transceiver in relation to the anchor device.

As should be appreciated, the TDoAoA process may be used in both uplink and downlink configurations.

### Flex TDoAoA Topology

With the goal of a real-time location system focused on easy, flexible deployment in real world facilities like hospitals, airports, parking structures, and the like, the previously disclosed TDoAoA processing must be incorporated into a flexible system topology. This topology must support wayfinding, robotics, asset tracking, and the maintenance of accurate digital twins in the facility while minimizing installed infrastructure. The flexible TDoAoA topology disclosed includes several features, such as:
(1) the IPS system anchors are operationally configured such that they operate in both uplink and downlink configurations simultaneously,
(2) the IPS system anchors are physically configured with antenna arrays and transceivers capable of AoA calculations,
(3) the IPS system anchors incorporate both UWB and BLE technologies, and,
(4) the IPS server utilizes TDoAoA fusion to calculate estimated positions of tags in the facility.

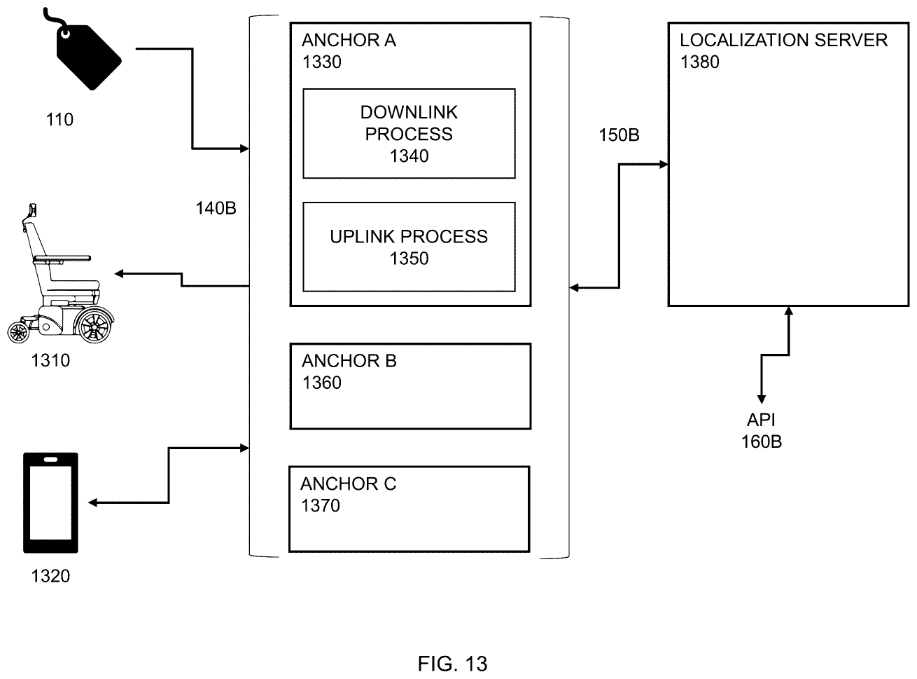

FIG. 13 depicts an exemplary flexible anchor topology. The flexible topology interacts with one or more tags 110, one or more robotic devices 1310, and/or one or more smart devices such as a smart phone 1320. Multiple anchors including Anchor A 1330, Anchor B 1360, and Anchor C 1370 are distributed throughout a facility, mounted at known locations in the facility. At least two anchors are installed, but three or more anchors may additionally or alternatively be installed. In some implementations, each anchor is physically configured with antenna arrays and transceivers capable of AoA calculations as previously disclosed. Each anchor is operationally configured to send downlink TDoAoA messages via a downlink process 1340 (e.g. as part of the anchor controller 340 which executes the process on the hardware anchor processor 330). Additionally, each anchor is operationally configured to send and receive uplink messages via an uplink process 1350 (e.g. as part of the anchor controller 340 which executes the process on the hardware anchor processor 330). The anchors communicate with a localization server 1380 via a wired or wireless communication link 150B. The localization server 1380 may communicate with external services and/or one or more of the devices in the facility (e.g. 1310 and 1320) via an API 160B.

Referencing FIG. 13, one or more tags 110 are configured to transmit one or more wireless signals (or blinks) via BLE and/or UWB 140B which is received by two or more anchors (e.g. anchors 1330, 1360 and 1370). In the example, a program executed by the tag processor 230 of the tag 110 is configured to transmit a wireless signal, which is a single, short-duration (typically on the order of nano- or microsecond) radio-frequency packet broadcast. Wireless signals are sent by the tag 110 at regular intervals, for example once a second, and may be sent more or less frequently to balance location update rates versus tag battery usage. The primary function of the transmitted packet is to serve as a time-stamped event that the anchors can use to determine the tag's location via Time Difference of Arrival (TDoA) and Angle of Arrival (AoA) measurements. As such, the transmitted packet (from the tag 110) may include the tag unique ID (e.g. a MAC address) as well as information such as the tag battery level or tag orientation if it includes an orientation sensor. Upon receiving a wireless signal from a tag 110, each anchor may independently record the exact time of arrival using its synchronized clock (i.e. via an uplink process 1350). The two or more anchors (e.g. 1330 and 1360) may independently receive wireless signals, timestamp the signals, calculate the angle-of-arrival of the signals, and combine the received and calculated data into a “blink packet” or record of the received wireless signal. An example of key blink packet data fields is included below in Table 1. The blink packet records may be immediately sent to the localization server 1380 (e.g. via a network interface 350 of the anchor). Additionally or alternatively, the blink packet record may be stored in memory (which is hardware) on the anchor and retrieved later to be sent by the anchor processor 330 via a network interface 350 to the localization server.

Field
Description

| | |
|---|---|
| Sequence Counter | Unique ID for the blink |
| Tag MAC Address | Unique identifier for the tag |
| RX Timestamp | Time anchor received the blink (for TDoA) |
| AoA Azimuth/Elevation | Angle measurements (if supported) |
| RSSI | Received Signal Strength Indicator |
| Frame Counter | For tracking and validation |

Each anchor independently forwards the one or more blink packet records (data including timestamps and any AoA measurements) to the localization server 1380. In an exemplary embodiment, each anchor is communicatively coupled with the localization server (150B) with either ethernet or via a wireless network connection such as WiFi Halo. One or more processes of the anchor (e.g. anchor controller 340 of the anchor processor 330) causes one or more control signals to be sent (e.g. via the network interface 350) to the localization server 1380 wherein a control signal is a wired or wireless signal, and wherein a control signal comprises one or more of a digital or an analog signal, and generally comprises or indicates data, instructions, and/or a state. In an example, one or more control signals may be a digital signal transmitted via a network protocol (e.g. ethernet) or interface (e.g. wireless network interface controller) designed to allow devices to communicate with each other in one or more applications.

The one or more control signals 150B containing blink packet records relevant to the tag 110 and sent from each anchor are received by the localization server 1380 (e.g. by the internal interface 410). The data from the one or more control signals is used by one or more processes of the localization server to calculate the estimated position of the tag 110 in the facility frame of reference. In an exemplary embodiment, the received control signals are received by an internal interface 410 of the localization server 1380 and stored in memory 440 for retrieval and use by one or more calculations of the IPS controller 450 on the localization processor 430. In this example, IPS controller 450 retrieves the blink packets related to the tag 110 (e.g. all blink packets received since last inquiry related to the tag unique ID). The Localization engine 530 of the IPS controller 450A then combines this data with other information (e.g. from memory), such as the precise location of each anchor that has reported data and the precise current time, and uses this data to calculate the estimated location of the tag. The estimated location of the tag is calculated using TDoAoA as previously disclosed above (referencing FIGS. 11-12). This process is then repeated for each tag, with one or more processes of the IPS controller of the localization server computing the tag's position by intersecting hyperbolas (from TDoA) combined with AoA data. The calculated, estimated tag positions may then be stored (e.g. in memory) for later use, used by one or more process of the localization server, and/or made available via an API 160B to external systems such as a robotic device 1310, smart device 1320 or another process of the localization server processor.

In another example of the flex topology, a robotic device 1310 may be configured to receive one or more wireless signals (or blinks) via BLE and/or UWB 140B which is received from two or more anchors (e.g. anchors 1330, 1360 and 1370) mounted at known locations within the facility. In this configuration the anchors, via a downlink process 1340, transmit periodic blink packets (sometimes called “anchor blinks” or “downlink blinks”). The robotic device 1310 (or any device operationally configured for downlink) listens or waits for these transmissions from anchors in range (e.g. 1330, 1360, 1370). In this way, the anchors downlink process 1340 effectively causes the anchor to behave like a tag periodically (e.g. 1 time per second) by sending a blink packet broadcast which can be used by other devices in the facility. In this example, the anchor controller 340, running on the anchor processor 330 of multiple anchors, is configured to transmit a wireless signal such as a single, short-duration (typically on the order of nano- or microsecond) radio-frequency packet broadcast. Wireless downlink signals are sent by the anchor 110 at regular intervals, for example once a second, and may be sent more or less frequently. The primary function of the transmitted packet is to serve as a time-stamped event that robotic devices 1310 and other smart devices 1320 can use to determine their location via Time Difference of Arrival (TDoA) and Angle of Arrival (AoA) measurements. As such, the transmitted packet (eg. from the anchor 1330) may look very similar to previously disclosed tag transmissions. In an example, the transmitted packets may include the anchor unique ID (e.g. a MAC address) as well as information such as the anchor position. Table 2 provides a comparison of exemplary uplink versus downlink broadcast configurations.

TABLE 2

| | Who | Who | | Processing |
|---|---|---|---|---|
| Topology | Transmits | Receives | Example Blink Packet Contents | Location |
| Uplink | Tag | Anchors | Tag ID, sequence, timestamp, minimal | Anchors/Server |
| | | | payload | |
| Downlink | Anchors | Robots, Smart | Anchor ID, timestamp, time sync info, | Device itself |
| | | Devices | possibly anchor position | |

With the anchors providing a downlink blink to the robotic device 1310, the robotic device may incorporate some or all of the hardware and/or software of an anchor (reference FIG. 3) and the localization server (reference FIG. 4). The robotic device 1310 receives the blinks from multiple anchors, measures the precise time of arrival for each, and computes its own position using TDoAoA. In an exemplary embodiment, a robotic device incorporates one or more antenna 310, a transceiver 320 operationally configured for UWB communications, and one or more processors capable of completing one or more functions of both the anchor controller 340 and the IPS controller 450 to calculate the position of the robot based on one or more received signals. Additionally, the robot may incorporate memory, additional sensors such as an orientation sensor, and external interfaces 420.

In this example, one or more antenna/transceiver pairs of the robotic device 1310 receive one or more signals 140B containing downlink blink data (reference Table 2) sent from two or more anchors. Upon receiving a wireless signal from an anchor, one or more process of the robotic device (e.g. software executed by the processor which is hardware) records the exact time of arrival and the received data in memory. A processor of the robotic device then calculates the angle-of-arrival of the signal and combines the received and calculated data or record of the received downlink wireless signal. The downlink blink packet record may be immediately used (e.g. by one or more processes of the robotic device). Additionally or alternatively, the downlink blink packet record may be stored in memory on the device and retrieved later for use by one or more processes of the robotic device.

The received data from the anchors may then be used by the IPS controller 450 (e.g. running on one or more processors of the robotic device). The data from the one or more downlink signals is used by the one or more processes of the IPS controller 450 to calculate the estimated position of the robotic device 1310 in the facility frame of reference. In an exemplary embodiment, the received control signals are retrieved from and used by one or more calculations of the IPS controller 450 on the processor. In this example, IPS controller 450 retrieves all the downlink blink packets received (e.g. all downlink blink packets received since last inquiry). The localization engine 530 of the IPS controller 450A then combines this data with other information (e.g. from memory) such as the precise location of each anchor that has reported data and the precise current time and uses this data to calculate the estimated location of itself. Time synchronization may be handled similarly to uplink messages where one or more primary units transmit timing messages which allow precise synchronization across the facility. The precise locations of each anchor that has reported data may be retrieved from memory (e.g. preloaded on the device), provided by an external API (e.g. 160B), or may be embedded in the downlink blink packet as data for use by one or more processes of the IPS controller 450.

In this way, the location of the robotic device is calculated using TDoAoA as previously disclosed (referencing FIGS. 11-12). The calculated, estimated position of the robotic device may then be stored (e.g. in memory) for later use, used by one or more processes of the device, and/or made available to external systems. The calculated, estimated position of the robotic device may be used by one or more process of the robotic device to control motors, actuators, drive controls, device settings, enable or disable device features, provide user feedback, and/or trigger a transceiver of the robotic device to transmit one or more signal (e.g. to transmit data to a remote server or send a control system to another device). In an example, the estimated position of the robotic device may be used by one or more process of the robotic device to cause a control signal which causes one or more motors or actuators of the robotic device to start, stop, or change operational state. This may cause, for example the robotic device to stop motion when it is determined by a process of the robotic device that the calculated, estimated position of the robotic device is outside of a stored, approved area of operation. In another example, the one or more process of the robotic device (e.g. a drive path manager) may use the calculated, estimated position to calculate a drive path and send one or more control signal which causes the robotic device to drive a specific path. In another example, one or more user interface element may generate an alert (e.g. audio messages, haptic or visual feedback) based on a rules engine of the robotic device in response to the received, estimated position. Additionally or alternatively, the robotic device may report its computed position back to the facility localization server 1380 via another channel (e.g., Wi-Fi, BLE, or UWB uplink) via an API 160B. In this case, a process of the robotic device sends one or more control signals with data (e.g. the estimated location) which are transmitted in response to the completion of the estimation process of the localization server of the robotic device.

In yet another example of the flex topology, a smart device 1320 may be operationally configured for both uplink and downlink operation. As an example, the smart device 1320 may use the downlink operation for calculating its own position on an onboard map for user wayfinding, while simultaneously allowing uplink communications to be sent to anchors in the facility for tracking the current smart device location on the central localization server. This configuration allows for separating the time dependency and update rates for wayfinding and facility coordination tasks. In an example, the downlink TDoAoA (as previously disclosed) blink messages (as previously disclosed) in the facility are sent often, to provide more up-to-date for wayfinding on smart devices 1320 and robotic devices 1310 while the uplink messages (as previously disclosed) from the smart device 1320 are sent less frequently. The differing rates of transmission of the downlink and the uplink messages may provide accurate, but less frequent location data about the smart device for receipt by anchors in the facility and the calculations of the localization server 1380. Additionally or alternatively, all devices in the facility may have access to downlink messages for use in wayfinding and localization tasks on the device (e.g. the calculated, estimated location of the device calculated by the localization server is used by one or more application of the smart device to convert the location into a graphical localization visualization in maps and navigation apps on the device and/or used to calculate the path from the estimated location to another location and provide directions) whereas only uplink messages from select, known devices (e.g. devices known as valid devices based on their MAC address) are accepted by facility anchors and passed on to the localization server 1380 for use by other connected devices in the facility.

In an embodiment, anchors (e.g. 1330, 1360, and 1370) may include one or more additional antenna and transceiver, such as BLE antenna and transceivers, in addition to UWB. Integration of BLE into the anchor supports tracking of legacy hardware like BLE tags. Additionally or alternatively, BLE may be used to establish communication with one or more devices in the facility such as tags 110, robotic devices 1310, and/or smart devices 1320. This additional communication with a device may be used transmit data which may assist with device identification, pairing, and data transfer with one or more anchors of the facility in some embodiments. In an embodiment, anchors (e.g. 1330, 1360, and 1370) may include one or more additional wireless antennas and transceivers, such as WiFi antenna and transceivers. The additional antenna/transceiver pair may be used for network interface (e.g. 350 FIG. 3) and for data backhaul, device diagnostics, device configuration, and/or software updates.

As such, some implementations of the present disclosure may include an indoor positioning system that includes a portable device located within a facility, the portable device comprising a first transceiver for transmitting a first location signal and receiving a second location signal, wherein the first location signal comprises a unique identifier of the first transceiver and a time of transmission for the first location signal and an anchor device comprising a second transceiver to receive the first location signal from the portable device or to transmit the second location signal to the portable device, signal, wherein the second location signal comprises a unique identifier of the second transceiver and a time of transmission for the second location signal. The indoor positioning system may also include a location server configured to determine a relative position of the portable device within the facility based at least on a first time delay of arrival (TDoA) and a first angle of arrival (AoA) of the first location signal received at the second transceiver, where the portable device further comprises a processor to determine a relative position of the portable device within the facility based at least on a second TDoA and a second AoA of the second location signal received at the portable device.

### Facility Integration

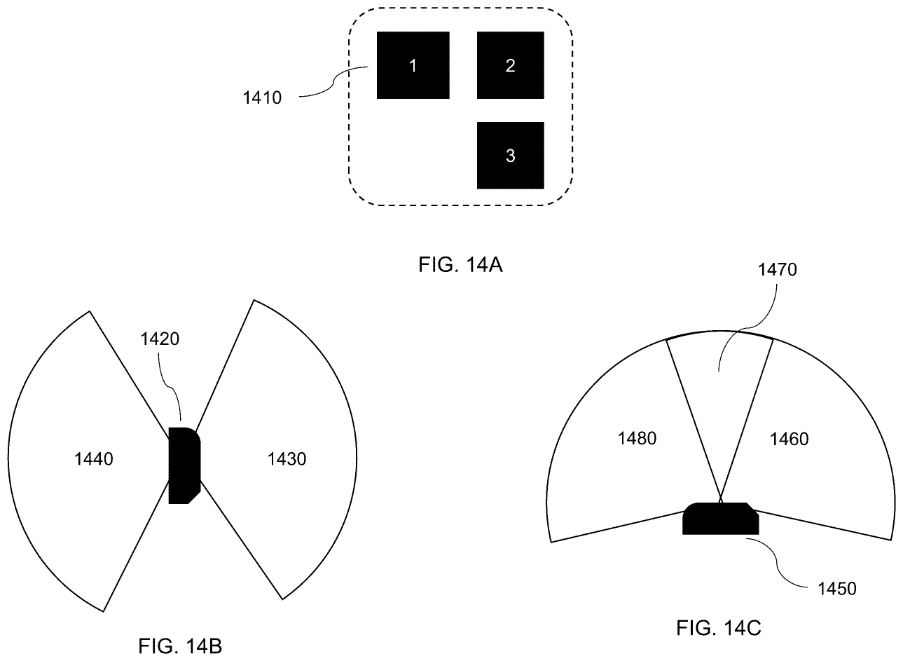

FIG. 14 depicts exemplary antenna configurations for a flexible IPS anchor. FIG. 14A depicts an example of a multi-element antenna configured for both TDoA and AoA measurement where three antenna elements 1410 are configured in an L shape to allow for calculation of both time and phase difference of received signals. FIGS. 14B and 14C depict examples of anchor embodiments where two or more multi-element antennas (reference FIG. 14A). The anchor embodiment 1420 depicted in FIG. 14B includes two or more multi-element antenna configured to operate in non-overlapping zones of coverage, 1430 and 1440 respectively. The anchor embodiment 1450 depicted in FIG. 14C includes two or more multi-element antennas configured to operate in overlapping zones of coverage where one antenna array is capable of receiving signals in the areas 1460 and 1470 while the other antenna array of the anchor is capable of receiving signals in areas 1480 and 1470. In this configuration, both multi-element antennas receive signals in the area of coverage 1470. In an exemplary embodiment, an IPS anchor is physically configured with multiple, multi-element antenna arrays and operationally configured with both a downlink process (e.g. 1340) and an uplink process (e.g. 1350). Additionally, one of the two antennas of the anchor may be configured to operate as a primary anchor, sending time sync messages, while the other antenna may be configured to operate as a secondary anchor, receiving a primary time sync message from another, separate primary anchor.

As such, some implementations of the present disclosure may include an indoor positioning system that includes a first transceiver comprising a first plurality of antennas configured in an L-shaped pattern on the first transceiver and a first processor and a second transceiver comprising a second plurality of antennas configured in an L-shaped pattern on the second transceiver and a second processor. The first processor may be configured to receive, at a first antenna of the first plurality of antennas, a first location signal, receive, at a second antenna of the first plurality of antennas, the first location signal, and determine a TDoA and an AoA of the first location signal. The second processor may be configured to receive, at a first antenna of the second plurality of antennas, a second location signal, receive, at a second antenna of the second plurality of antennas, the second location signal, and determine a TDoA and an AoA of the second location signal. The first plurality of antennas and the second plurality of antennas may also be located within a facility with at least partial overlapping zones of coverage.

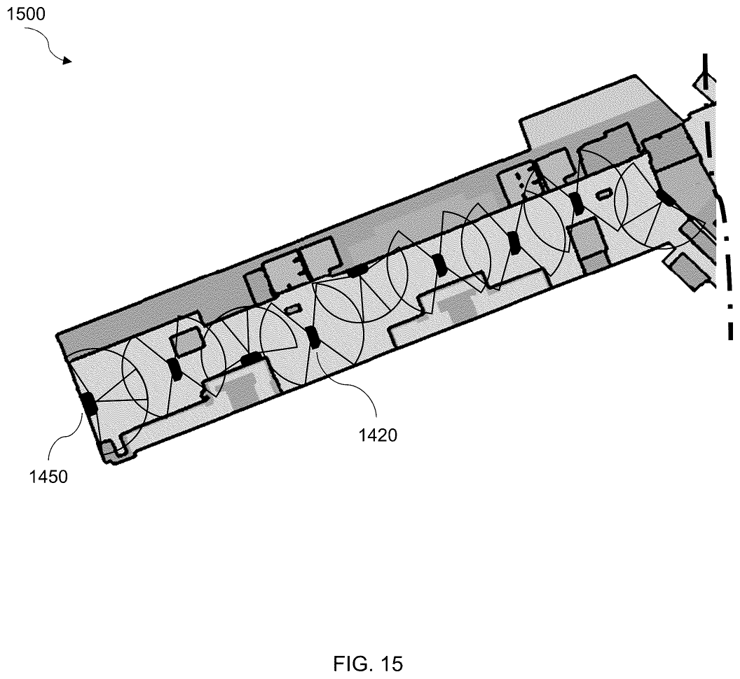

FIG. 15 depicts an example anchor layout in a part of a large facility according to aspects of the present disclosure. The figure depicts a floorplan view of a generic large facility such as an airport or hospital. The use of multi-antenna anchors such as 1420 and 1450, installed in the facility with overlapping areas of coverage allows for IPS localization deployment across large facilities with minimal installed infrastructure. In the example shown, the ability to send and receive signals throughout the facility is maximized by using some anchor configurations 1420 for linear layouts and corridors (e.g. airport concourses) while using other anchor configurations 1450 for open spaces like entry areas.

### Wayfinding Example

In an example of how the flexible IPS system disclosed may be used to enable wayfinding through a maps application running on a smart device (e.g. 1320) in a facility (e.g. of FIG. 15), when a user of the smart device enters the facility equipped with one or more anchors, the smart device's UWB transceiver automatically detects UWB signals from nearby anchors (e.g. 1330, 1360, 1370). In a practical implementation within an airport terminal, a user of the smart device would experience the following sequence:
1. Upon entering the terminal, the user opens the maps application and selects their gate as the destination,
2. The smartphone's UWB transceiver receives one or more signals from the airport's one or more IPS anchors,
3. The application processor of the smart device calculates the user's position within the terminal,
4. The navigation software of the smart device determines the optimal route to the gate, accounting for accessibility requirements,
5. As the user moves through the terminal, the application of the smart device provides timely directions: “Proceed 50 meters forward, then turn right at the food court”,
6. The system continuously updates the user's position, recalculating the route as necessary, and,
7. Upon approaching the destination, the application of the smart device confirms arrival: “You have reached Gate B12”.

In the example, the maps application activates the smart device IPS module, which initializes the UWB transceiver of the smart device 1320 which is powered via the device's communication processor. The application processor of the smart device 1320 allocates resources for position calculation algorithms and the sensor processor of the smart device begins monitoring for incoming UWB signals. The smart device 1320 receives synchronized blink messages from one or more anchors within range (e.g. from a downlink process 1340 of an anchor). Each anchor transmits at precisely timed intervals, coordinated by a primary anchor. The UWB transceiver in the smart device receives the blink signals. The communication processor of the smart device timestamps each received signal with high precision. The application processor of the smart device calculates time differences and angles of arrival (e.g. azimuth and elevation angles) between signal arrivals.

The smart device's application processor then executes algorithms to determine the device's precise location. The smart device processor applies TDoAoA techniques as previously disclosed. The calculated position is referenced against the facility's digital map coordinates where the map correlation is retrieved from memory from the smart device. Position accuracy is typically sub-meter when receiving signals from at least two anchors.

Once the device's position is established, the maps application integrates this information with the facility's digital map (e.g. from memory). The application processor overlays the user's position on the facility map. The navigation algorithm calculates the optimal route to the destination based on: current position, destination coordinates, accessibility requirements, known obstacles, and/or restricted areas. The route is segmented into navigable waypoints for turn-by-turn guidance. In an embodiment, the navigation algorithm may employ A* navigation or similar pathfinding and graph traversal algorithms.

The maps application provides continuous turn-by-turn directions to the user via voice, text, or a graphical user interface. The UWB transceiver of the smart device continuously receives anchor signals. The application processor of the smart device updates the user's position. The navigation software compares the current position against planned waypoints. When approaching a turn or decision point, the application processor triggers appropriate directional guidance through the user interface, to the user. The user interface presents visual and audio cues for navigation.

To accomplish these tasks the smart device maps application's navigation module may consists of several software components including:
Position calculation engine: Processes UWB signals and determines device location
Map rendering engine: Displays facility map and user position
Route planning algorithm: Calculates optimal path to destination
Navigation controller: Manages turn-by-turn guidance delivery
Sensor integration module: Fuses data from multiple positioning technologies (UWB, BLE, IMU)
Communications manager: Handles data exchange with facility IPS servers

The system leverages multiple communication channels to enhance the navigation experience. The smartphone's Wi-Fi or cellular transceiver may communicate with the facility's IPS server (e.g. via an API) to receive updated map information. Bluetooth Low Energy (BLE) may be used as a supplementary positioning technology in areas with limited UWB coverage. The application may utilize long-range communications networks (e.g. HaLow) for high-priority communications when cellular service is unavailable.

### Robot Example

Indoor positioning systems (IPS) play a pivotal role in enabling autonomous robotic devices (e.g. 1310) to navigate indoor environments such as warehouses, hospitals, and airports. The main function of the proposed indoor positioning system is to determine the accurate location of items in the indoor environment. This information is useful to robotic devices as it enables robust autonomous navigation as well as provides location information for operations systems of large facilities to help get the right people and resources to the right places at the right time. The proposed IPS system may be used in different facilities such as airports or hospitals, with each environment presenting unique challenges for robotic navigation. In an embodiment, the IPS utilizes Time Difference of Arrival with Angle of Arrival (TDoAoA) topology to provide location accuracy for robotic device navigation.

In an example, a robotic device may navigate a facility (e.g. 1500) with an installed IPS system (e.g. 100), where the IPS system employs a network of anchors strategically placed throughout the facility to provide coverage, accuracy, and operationally configured to provide position update rates needed for robotics applications. The robotic device (e.g. 1310 of FIG. 13) may either receive location information wirelessly via an API 160B or utilize incoming downlink blink packets as previously disclosed to calculate its current location using one or more processors of the robotic device. In either case the one or more processes of the robotic device have, based on the disclosed IPS system operations, an estimated location available that can be used for autonomous robotic device navigation and for path planning and drive execution.

In an embodiment, the estimated location (e.g. data) is integrated with a situational awareness controller (SAC) of a robotic device. The SAC, which is software, maintains a situational awareness map of the surroundings based on data provided by various sensors of the robotic device and the location data. The drive path manager of the robotic device references this situational awareness map when executing autonomous navigation and drive maneuvers. The combination of sensors available to the robotic device controller includes multiple onboard sensors, information available from remote services, and third-party information, which together support creation of a precise situational awareness map onboard the robotic device. Real-time obstacle detection and avoidance calculations may integrate IPS localization data with sensor fusion techniques in an embodiment.

For example, when a robotic device detects an obstacle through its onboard sensors, the precise location data (e.g. enabled or received by IPS) allows the system to accurately map the obstacle's position relative to the robot and surrounding environment in a facility frame of reference. This integration enables the robotic system to make informed decisions about avoidance strategies based on both the immediate sensor data and the calculated (e.g downlink), or received (e.g. uplink), position data. For example, when navigating a crowded airport terminal, a robotic device can use location data received from the IPS to determine its exact position within the terminal as previously disclosed, while simultaneously using onboard sensors to detect and track moving obstacles, such as passengers proximate to the robotic device. The fusion of these data streams allows one or more processors of the robotic device to calculate optimal avoidance trajectories, drive paths and plan actions with one or more process that causes a processor of the robotic device transmit one or more control signals which causes an action based on the location data of the localization server. In this way, the IPS location may be used to maintain safe distances from obstacles while still progressing efficiently toward its destination. Additionally, the location data enables one or more processes of the robotic device to distinguish between temporary obstacles that require immediate avoidance and permanent features of the environment that should be incorporated into the situational awareness or navigation map.

In another example, the integration of location data with one or more situational awareness systems of the robotic device creates a multi-layered understanding of the environment that enhances robotic navigation capabilities. The situational awareness controller (SAC), which is software that runs on one or more processors of the robotic device, utilizes location data as a foundational layer upon which additional, onboard sensor data is overlaid to create a comprehensive environmental model. This integration allows the robotic system to maintain awareness of its absolute position within the facility while simultaneously tracking the relative positions of nearby objects, conditions, and events. The tactical manager within the SAC maintains this situational awareness map and continuously updates it based on new sensor inputs and received or calculated, updated location data. The drive path manager of the robot SAC references this integrated map when planning and executing navigation paths, enabling the robotic device to navigate complex indoor environments with precision and safety.

In some embodiments, the situational awareness map maintained by the tactical manager of the SAC on the robotic device incorporates information from the collision manager and stability manager and their associated sensors. While the location data provides an estimate of absolute location, the situational awareness map provides information on safe directions of travel and distances to surrounding objects. For example, when a robotic device is traveling down a hallway, the navigation system may maintain the current location and target end location via messages received or calculated from signals from the IPS, while the SAC is aware that the robot may stay between the two walls to reach that location. The drive path manager of the SAC then references this integrated situational awareness map when executing autonomous navigation. This added awareness allows navigation of tight spaces that would not otherwise be possible with dead reckoning alone.

In another example, the IPS system may also facilitate communication between multiple robotic devices operating in the same environment. In one embodiment, two or more robotic devices equipped with UWB transceivers can form an ad hoc network with each other for exchanging messages. The contents of messages transmitted between the devices may include information relevant to navigation, such as current location and kinematic state. Additionally, the messages may share location and kinematic state of tracks each device is tracking with its sensors. These tracks may then be translated by the receiving device from a vehicle frame of reference to a facility or earth frame of reference and added to or combined with existing tracks on the SAC situational awareness map of the robotic device. In this way, multiple robotic devices can benefit from enhanced situational awareness through cooperative targeting of objects, conditions, and events proximate to each using shared location data for translation of data between different frames of reference (e.g. using calculations on a processor of the robotic device).

The IPS derived or received location data also enables robotic devices to create and maintain detailed maps of the indoor environment. The same sensors and advanced navigation systems that allow a robotic device to avoid dangerous obstacles may be additionally used to capture valuable data regarding accessibility, terrain, and preferred paths as the device navigates through the environment. This data may be used both to create maps of areas that have not yet been mapped with the level of detail required for autonomous navigation and to update areas that have already been mapped. The increased accuracy of dual mode variance readings may aid in producing high-quality maps. In some embodiments, the combination of camera data and distance data may allow the SAC to create extremely detailed 3D digital recreations of locations and features based on the situational awareness map.

### IPS Integration

The IPS system's flexibility in communication options allows it to be deployed in various facility types. In some instances, location data is made available to other partners at the facility via an easy-to-use API, enabling integration with existing systems and third-party applications. It provides position data to external applications through an API to allow robots, third-party applications, and/or local or remote services to access real-time location information. The API may support various data formats and query methods, enabling integration with diverse systems such as:
Autonomous navigation systems for robots,
Guest wayfinding applications,
Asset tracking systems,
Facility management platforms, and,
Digital twin implementations.

The API architecture comprises several key components:
Location Data Service: Provides real-time position information for all tracked assets
Zone Management Service: Handles geofencing and zone-based operations
Asset Status Service: Reports operational status of tracked robots
Event Notification Service: Delivers alerts and notifications based on predefined conditions
Historical Data Service: Provides access to stored location data for analysis

Each of these services exposes endpoints that can be accessed by authorized fleet management applications using protocols such as REST or WebSocket for real-time data streaming. The Location Data Service forms the core of the fleet management API, providing precise position information for some or all tracked assets in the facility. This endpoint provides comprehensive position data including coordinates, orientation, timestamp, accuracy metrics, and velocity information. Systems can poll this endpoint at regular intervals or establish a WebSocket connection for real-time updates. The IPS enables sophisticated automated dispatching by providing accurate real-time location data that can be used to make intelligent decisions about which tracked assets to assign to specific tasks. The API also allows for a dispatching system to submit new tasks, which may then be automatically assigned to the most appropriate asset based on current location, capabilities, and workload. The response includes estimated times and the planned route. The automated dispatching system can implement or execute assignment algorithms that leverage the precise location data of the IPS. These algorithms consider multiple factors beyond just proximity, creating a balanced approach to task assignment that optimizes overall fleet efficiency.

The IPS may facilitate real-time coordination between multiple robotic devices operating in the same area. One or more APIs (e.g. of the IPS system) may provide information and/or data, such as a real-time map of congestion areas, or other conditions, where multiple robots are operating in close proximity, along with recommended routes to avoid these areas. Systems can then use this information to dynamically reroute robots and prevent traffic jams. The IPS can, in an embodiment, also support direct robot-to-robot communication. This right-of-way API enables robots to negotiate right-of-way when their paths are predicted to intersect, reducing the likelihood of deadlocks and improving overall traffic flow in the facility.

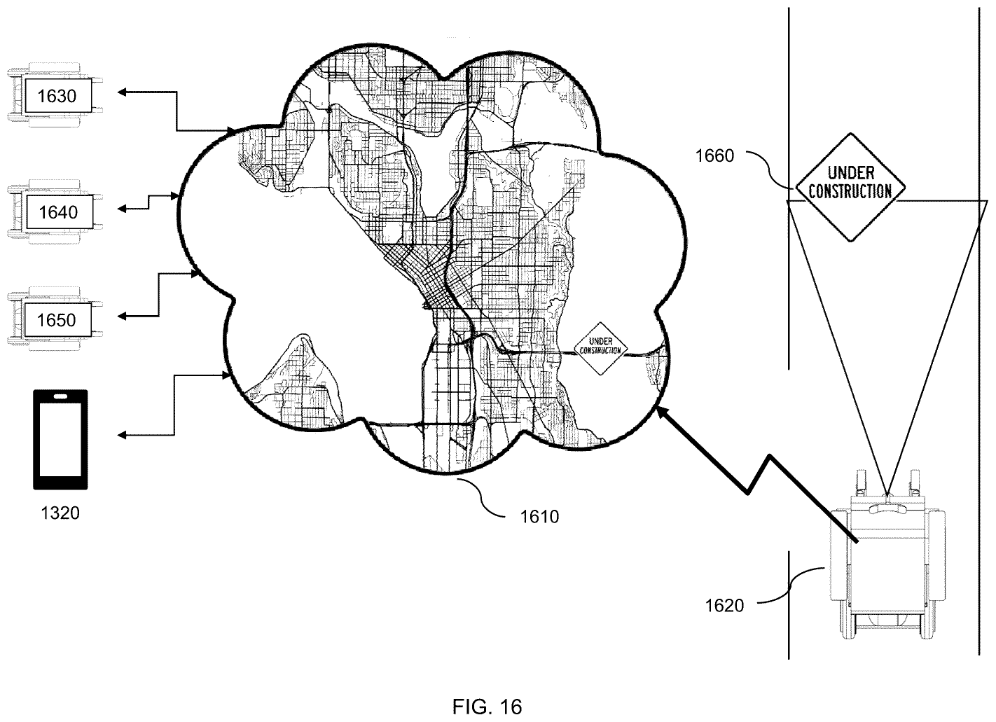

FIG. 16 depicts an embodiment of a shared, real-time map of an area being updated and used by multiple devices. In the example, a map of the area 1610, which is data, is stored in memory of the localization server (e.g. 130) and updated by one or more processes, calculations, or logical operations of the localization server processor. In the example, a robotic device 1620 is communicatively coupled to the localization server via wireless communication, using an API (e.g. 160) to send and receive data via signals over the wireless communication protocol. Multiple other robotic devices (e.g. 1630 thru 1650) and smart devices (e.g. 1320) are also communicatively coupled (e.g. via wireless or wired communications) to send and receive data about the map 1610 via the API. When the robotic device 1620 recognizes an unmapped obstacle or change in the map compared to the received data, from the shared map 1610 (such as an area of construction 1660), one or more processes of the robotic device sends data back via the API to the localization server. When the data is received, one or more processes of the localization server updates the map and communicates the updated data to other devices (e.g. 1620-1650 and 1320) for use by one or more processes of the connected devices. In some embodiments, the localization server may update the map 1610 automatically based on one or messages received from a device via the API. In another embodiment, a machine learning engine on the localization server may be configured to recognize and mark features based on data received from many connected devices. Additionally or alternatively, rules, such as a confidence level, may be established and enforced by a rules engine of the localization server before the shared map 1610 data is modified. As more robotic devices navigate an area and upload their data, maps become more accurate and stay up to date. In some embodiments, robotic devices may insert markers to alert others of potential hazards that may affect navigation in an area. The robotic devices may add such markers to a map automatically by detecting areas that must be consistently avoided, areas that must be consistently traversed, and/or by using feature recognition. In one embodiment, a machine learning engine on a remote server may be configured to recognize and mark these features based on data compiled from many devices.

The IPS supports zone-based operations through a dedicated geofencing API. This API allows fleet management systems to define different operational zones within a facility, such as charging areas, pickup/drop-off points, and restricted zones. The IPS can then trigger events when robots enter or exit these zones. In an example, a robotic device 1310 is communicatively coupled with the localization server 1380 via the dedicated geofencing API (e.g. a part of 160B). When the localization server's calculated, estimated location of the robotic device 1310 is within a set of boundaries identified as a pickup zone (e.g. from memory on the localization server) the localization server transmits a message via the API to one or more process of the robotic device which causes one or more control signal to be sent on the robotic device that causes a display of the robotic device to light up with a message such as “available” to communicate its current state.

The IPS provides comprehensive analytics capabilities through dedicated API endpoints. This data enables fleet managers to identify underutilized robots, optimize fleet size, and improve overall operational efficiency.

By leveraging the comprehensive API capabilities of the LUCI Flex IPS, organizations can implement sophisticated fleet management systems that optimize robot utilization, minimize response times, and maximize operational efficiency in complex indoor environments. The system's ability to provide sub-meter accuracy location data in real-time forms the foundation for intelligent dispatching decisions, while its support for zone-based operations and traffic management enables smooth coordination of multiple robots in shared spaces.

### Operations Dashboard

The disclosed IPS system (e.g. 100) plays a pivotal role in supporting efficient operations management through accurate tracking and enabling precise real-time monitoring and management of connected devices in large-scale facilities such as warehouses, airports, and hospitals. The IPS provides comprehensive tracking capabilities that form the foundation of efficient fleet operations. As previously disclosed, the IPS system utilizes a network of strategically placed anchors throughout a facility to track the position of UWB tags, connected devices, and provide position information to robotic devices with accuracy. This precise location data is made available via an API, enabling integration with fleet management systems and third-party applications. When the outputs of the IPS system are integrated with an operations management system, significant operational efficiencies are possible.

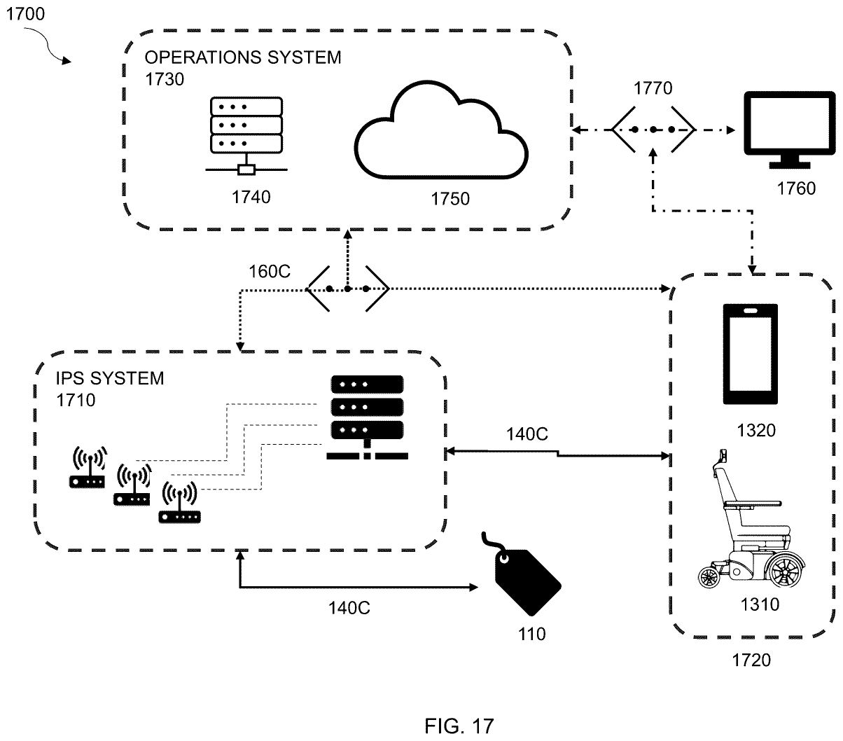

FIG. 17 depicts a facility operations management system, which integrates an IPS system, where multiple, external sources are incorporated. In the example, an IPS system 1710 comprised of one or more anchors and a communicatively coupled localization server interact as previously disclosed 140C with one or more tags 110 and other devices 1720 (e.g. smart devices 1320 and robotic devices 1310). Additionally, the IPS system communicates via an API 160C with an operations system 1730. In some embodiments, the IPS system may additionally communicate directly with the other devices 1720 via an API 160C. The operations system 1730 may be comprised of local computer 1740 and/or cloud computer 1750 resources where local and cloud computer resources are processors and memory operationally configured to run software and communicatively coupled (e.g. via network communications) with the IPS system 1710. In the example, the operations system 1730 provides an API 1770 which may be used by third parties such as kiosks, apps, computers, or other systems. Additionally, the operations system API 1770 may be used by one or more connected device 1720. In the embodiment, the operations system 1730 may perform one or more coordination or data sharing activity previously disclosed as part of the localization server of the IPS. In an embodiment, the operations system 1730 may serve as the primary interface (e.g. API 1770) for users external to the facility.

The disclosed system, in an example, is built on a secure IoT stack, ensuring data integrity and privacy while providing the up-to-date information needed for efficient fleet operations. By leveraging the precise location data provided by the IPS, organizations can implement sophisticated management systems that optimize resource utilization, minimize response times, and maximize operational efficiency in complex environments. In an exemplary embodiment, the IPS system 1710, including the localization server, are local systems which communicate location data of all devices (e.g. 110 and 1720) to a remote server (e.g. 1730) via the API 160C. The local IPS system 1710 is operationally configured to operating rates that are specifically designed for live positioning (e.g. 1 Hz in an embodiment) so that locally connected devices 140C can get location data frequently. At the same time, the remote API 160C is operationally configured so that cloud-based system updates are provided at a slower rate (e.g. 30 seconds). This separation of timing allows critical dynamic functions to be handled locally while more computer or time-consuming operations may be handled remotely on remote resources. Additionally or alternatively, one or more function of the operations system 1730 may be accomplished by a local resource 1740.

With accurate real-time location data from the IPS system 1710, the operations system 1730 may host an automated dispatching system (which is software, run on one or more processor of the operations system) that can make intelligent decisions about which connected robotic devices (e.g. 1310 connected via 1770) to assign to specific operational tasks such as deliveries based on the devices current positions relative to task locations. This capability, of the operations system 1730, significantly reduces response times and minimizes unnecessary travel distances. In an example, an automated dispatching system of a remote operations system 1750:
1. Identifies the nearest available robot to a requested task location where the task is requested through a user interface,
2. Calculates optimal route based on current facility conditions using data from an IPS system 1710,
3. Transmits one or more message (e.g. via an API 1770) to the selected robotic device(s) (e.g. 1310) to assign a task including, in some embodiments, the assigned optimal path, and,
4. In some cases, may dynamically reassign tasks when operations priorities change.

In another example of an operations system 1730, The system's ability to monitor which devices (e.g. with software running on a processor of the operation system) are entering and exiting defined zones (e.g. defined in memory of the operations system) further enhances dispatching efficiency by allowing fleet managers to establish restricted areas, priority zones, and specialized operational domains. In an example of geofencing, the operations system 1730 receives updated location data for a smart device (e.g. 1320) from the IPS system 1710 via a network communication API 160C wherein the received location of the smart device has coordinates that are within a defined zone of the facility that is restricted. In this example, one or more logical comparison or calculation of the operations system 1730 will cause the operations system to both: (a) transmits one or more message (e.g. via an API 1770) to the device, and, (b) transmit one or more message to an operations management user interface running on an external device 1760 to alert management personnel of the breach of the restricted zone.

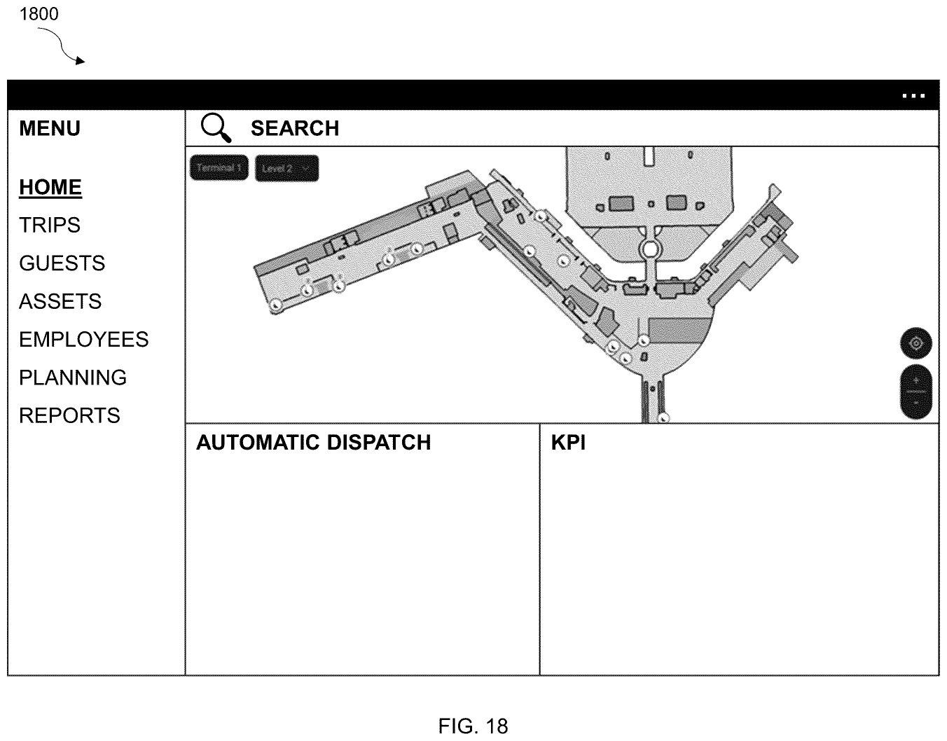

FIG. 18 depicts an embodiment of an operations management user interface (e.g. 1760) that uses IPS outputs. The depicted user interface 1800 consists of a menu of key functions, a search bar to allow quickly finding assets tracked by the IPS, a fused map of the facility showing the location of tracked assets, a field for automatic operations dispatch updates, and a field for tracking key performance indicators for the operations of the facility. Key functions for the system 1700, that are displayed on the user interface 1800 include:
All trips by guests, assets, and employees in the facility,

An up-to-date list of any guests in the facility and where they are located,

An up-to-date list of any assets (e.g. tags, smart devices, and robotic devices) in the facility and where they are located,
An up-to-date list of any guests in the facility and where they are located,
Planning tools for scheduling future trips, and,
Reporting tools for viewing historical data about past activities within the facility.

When the IPS system 1710 is integrated with an operations system 1730, the combined system 1700 is capable of providing advance features such as:
Up-to-date position data for all tracked assets,
Historical movement patterns for optimization analysis,
Dwell time analysis to identify bottlenecks in facility navigation,
Collision risk assessment based on proximity data, and,
Utilization metrics for each robotic device in the facility.

In an example, IPS data (e.g. 160C) may be used by one or more process of the operations system 1730 for resource optimization. By providing precise location data, the IPS enables fleet management systems to optimize resource allocation. The system can identify underutilized robotic devices and redirect them to areas with higher demand. Similarly, it can identify areas where robotic devices are congregating unnecessarily and redistribute them to improve overall facility operations coverage.

In an example, IPS data may be used by one or more process of the operations system 1730 for predictive dispatching of operational assets. With historical data collected and stored in memory, the operations system can implement predictive dispatching algorithms that anticipate demand patterns and position robotic devices accordingly. For example, in an airport setting, robotic mobility assistants could be automatically dispatched to gates shortly before flights arrive, anticipating passenger assistance needs.

In an example, IPS data may be used by one or more process of the operations system 1730 for automated coordination. The system facilitates communication between multiple robotic devices operating in the same environment. Robots equipped may form a network for exchanging messages about their current location, kinematic state, and tracked objects via the API 1770. This information can be translated from a vehicle frame of reference to facility frame of reference and added to a situational awareness map (e.g. 1610 FIG. 16) stored on the operations system 1730 and shared with all connected devices, enabling coordinated fleet operations. In an embodiment, the system may create and maintain a central map, built from a combination of data received from the IPS system, miscellaneous facility sensors (e.g. lidar or camera based pedestrian traffic estimation sensors), and other external sources (e.g. flight schedules in an airport) that is then shared with robotic devices and smart devices in the facility (e.g. via the API 1770).

In an example, IPS data may be used by one or more process of the operations system 1730 to optimize maintenance. The system can track robotic device movement patterns and identify anomalies that might indicate maintenance needs (e.g. with software such as a LLM trained to recognize deviations from typical performance run on one or more processor of the operations system). For example, a robot that begins to deviate from expected paths or moves more slowly than usual might require service. By identifying these issues early and displaying a warning on a user interface (e.g. 1800), managers can schedule preventative maintenance before failures occur.

This integration of IPS system data in a facility operations management system 1700 enables fleet management systems to make informed decisions based on both the absolute positions of devices and their relationships to other objects, conditions, and events in the environment.

### Non-Transitory Computer Readable Medium

The various operations of methods described above may be performed by any suitable means capable of performing the operations, such as various hardware and/or software component(s), circuits, and/or module(s).

The various illustrative logical blocks, modules, and circuits described in connection with the present disclosure may be implemented or performed with a hardware processor, a digital signal processor (DSP), an application specific integrated circuit (ASIC), a field programmable gate array signal (FPGA) or other programmable logic device (PLD), discrete gate or transistor logic, discrete hardware components, or combinations thereof designed to perform the functions described herein. A hardware processor may be a microprocessor, commercially available processor, controller, microcontroller, or state machine. A processor may also be implemented as a combination of two computing components, e.g., a combination of a DSP and a microprocessor, a plurality of microprocessors, one or more microprocessors in conjunction with a DSP core, or any other such configuration.

In one or more aspects, the functions described may be implemented in software, firmware, or any combination thereof executing on a hardware processor. If implemented in software, the functions may be stored as one or more executable instructions or code on a non-transitory computer-readable storage medium. A computer-readable storage media may be any available media that can be accessed by a processor. By way of example, and not limitation, such computer-readable storage media can comprise RAM, ROM, EEPROM, CD-ROM or other optical disk storage, magnetic disk storage or other magnetic storage devices, or any other medium that can be used to store executable instructions or other program code or data structures and that can be accessed by a processor. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims. Processes or steps described in one implementation can be suitably combined with steps of other described implementations.

Certain aspects of the present disclosure may comprise a computer program product for performing the operations presented herein. For example, such a computer program product may comprise a computer readable storage medium having instructions stored (and/or encoded) thereon, the instructions being executable by one or more processors to perform the operations described herein.

Software or instructions may be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a terminal and/or base station can obtain the various methods upon coupling or providing the storage means to the device.

For the sake of convenience, the operations are described as various interconnected functional blocks or distinct software modules. This is not necessary, however, and there may be cases where these functional blocks or modules are equivalently aggregated into a single logic device, program, or operation with unclear boundaries. In any event, the functional blocks and software modules or described features can be implemented by themselves or in combination with other operations in either hardware or software.

Having described and illustrated the principles of the systems, methods, processes, and/or apparatuses disclosed herein in a preferred embodiment thereof, it should be apparent that the systems, methods, processes, and/or apparatuses may be modified in arrangement and detail without departing from such principles. Claim is made to all modifications and variation coming within the spirit and scope of the following claims.

What is claimed is:

1. A method for locating a device in an indoor facility, the method comprising:
transmitting, by a first transceiver to a second transceiver and a third transceiver, a first signal;
determining, by a processor, a first time delay of arrival (TDoA) and a first angle of arrival (AoA) of the first signal based on the second transceiver receiving the first signal;
determining, by the processor, a second TDoA and second AoA of the first signal based on the third transceiver receiving the first signal;
calculating, based on the first TDoA, the first AoA, the second TDoA, and the second AoA, an estimated location of the first transceiver in relation to an anchor device; and
calculating, based on the first TDoA, the first AoA, the second TDoA, and the second AoA, an estimated uncertainty of the location of the first transceiver in relation to the anchor device.

2. An indoor positioning system comprising:
a portable device located within a facility, the portable device comprising a first transceiver for transmitting a first location signal and receiving a second location signal, wherein the first location signal comprises a unique identifier of the first transceiver and a time of transmission for the first location signal;
an anchor device comprising a second transceiver to receive the first location signal from the portable device or to transmit the second location signal to the portable device, signal, wherein the second location signal comprises a unique identifier of the second transceiver and a time of transmission for the second location signal; and
a location server configured to determine a relative position of the portable device within the facility based at least on a first time delay of arrival (TDoA) and a first angle of arrival (AoA) of the first location signal received at the second transceiver, and
wherein the portable device further comprises a processor to determine a relative position of the portable device within the facility based at least on a second TDoA and a second AoA of the second location signal received at the portable device.

3. An indoor positioning system comprising:
a first transceiver comprising a first plurality of antennas configured in an L-shaped pattern on the first transceiver and a first processor, the first processor configured to:
receive, at a first antenna of the first plurality of antennas, a first location signal;
receive, at a second antenna of the first plurality of antennas, the first location signal; and
determine a time delay of arrival (TDoA) and an angle of arrival (AoA) of the first location signal; and
a second transceiver comprising a second plurality of antennas configured in an L-shaped pattern on the second transceiver and a second processor, the second processor configured to:
receive, at a first antenna of the second plurality of antennas, a second location signal;
receive, at a second antenna of the second plurality of antennas, the second location signal; and
determine a TDoA and an AoA of the second location signal,
wherein the first plurality of antennas and the second plurality of antennas are located within a facility with at least partial overlapping zones of coverage.
